(19) United States
(12) Patent Application Publication
(10) Pub. No.: US 2025/0342585 A1
(43) Pub. Date: Nov. 6, 2025

(54) CODESIGN OF STAIN-FREE ALL-IN FOCUS IMAGING WITH DEEP LEARNING

(71) Applicants: California Institute of Technology, Pasadena, CA (US); Washington University, Saint Louis, MO (US)

(72) Inventors: Haowen Zhou, Pasadena, CA (US); Siyu Lin, Pasadena, CA (US); Changhuei Yang, South Pasadena, CA (US); Richard J. Cote, Saint Louis, MO (US); Mark Watson, Saint Louis, MO (US); Govindan Ramaswamy, Saint Louis, MO (US)

(21) Appl. No.: 19/195,714

(22) Filed: Apr. 30, 2025

Related U.S. Application Data
(60) Provisional application No. 63/641,581, filed on May 2, 2024.

(51) Int. Cl. G06T 7/00; G06T 7/11; H04N 23/56

(52) U.S. Cl. CPC G06T 7/0012; G06T 7/11; H04N 23/56; G06T 2207/10056; G06T 2207/20021; G06T 2207/20081; G06T 2207/20084; G06T 2207/30096

(57) ABSTRACT

Techniques for computationally generating a faux-stain image of an unstained sample using intensity measurements of visible light and ultraviolet light through, or reflected by, the unstained sample. In some cases, the faux-stain image is provided as input to a trained deep neural network and an outcome prediction such as likelihood of metastasis is determined based on output of the trained deep neural network.

### CROSS-REFERENCES TO RELATED APPLICATIONS

This application claims benefit of and priority to U.S. Provisional Patent Application No. 63/641,581, titled “Cancer Prognosis Through Integrated Codesign of the Prep, Hardware, and Deep Neural Network,” and filed on May 2, 2024, which is incorporated by reference herein in its entirety and for all purposes.

### FIELD

Certain aspects generally pertain to computational imaging techniques and machine learning models, and more specifically, to deep neural networks for outcome predictions using, as input, computationally generated faux-stained images of unstained samples.

### BACKGROUND

Progression of various diseases, such as various types of cancer, are typically predicted by humans, such as pathologists or oncologists. For example, given an incidence of cancer, a pathologist may review biopsy slides and may characterize the tumor as likely to metastasize, or not likely to metastasize. An oncologist may then make treatment determinations based on the likelihood of metastasis. However, predicting disease progression can be difficult and/or inaccurate, which can cause suffering for patients. For example, in an instance in which a tumor is incorrectly predicted as not likely to metastasize, lack of treatment may cause more severe disease, or death. Conversely, in an instance in which a tumor is incorrectly predicted to metastasize, more aggressive treatment may be started, which may produce side effects that could be avoided if it were known prior to aggressive treatment that the tumor is not likely to metastasize.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Techniques disclosed herein may be practiced with a processor-implemented method, a system comprising one or more processors and one or more processor-readable media, and/or one or more non-transitory processor-readable media.

According to some embodiments, a method includes (a) computationally generating a faux-stain image of an unstained specimen using a plurality of first intensity measurements of light in a first wavelength range and at least one second intensity measurement of light in a second wavelength range, (b) providing the faux-stain image as input to a trained deep neural network, and (c) determining an outcome prediction based on output of the trained deep neural network. In some cases, the method may further involve causing, using one or more first light sources, light in the first wavelength range to be emitted at a plurality of illumination angles sequentially and causing, using one or more second light sources, light in a second wavelength range to be emitted.

According to some embodiments, a method includes causing, using one or more first light sources, light in a first wavelength range to be emitted at a plurality of illumination angles sequentially, obtaining, using a first light detector, a plurality of first intensity measurements indicative of light transmitted through, or reflected by an unstained specimen, the plurality of first intensity measurements corresponding to respective plurality of illumination angles, and generating a first image from the plurality of first intensity measurements. The method also includes causing, using one or more second light sources, light in a second wavelength range to be emitted and obtaining, using a second light detector, a second image indicative of light in the second wavelength range absorbed by the unstained specimen. In addition, the method includes combining the first image and the second image to produce a faux-stained image. In one case, the first image is a phase image, for example, reconstructing the phase image from the plurality of first intensity measurements using an angular ptychographic imaging with closed form procedure.

According to some embodiments, a system for determining an outcome prediction from an unstained specimen using deep learning includes an illumination device, a first light detector, a second light detector, and one or more processors. The one or more processors are configured to cause the illumination device to emit light in a first wavelength range and a second wavelength range, obtain, using the first light detector, information indicative of light of the first wavelength range reflected by, or transmitted through, the unstained specimen, and obtain, using the second light detector, information indicative of light of the second wavelength range reflected by, or transmitted through, the unstained specimen. The one or more processors are further configured to: based on the information obtained from the first and second light detectors, computationally generate a faux-stain image of the unstained specimen, provide the faux-stain image as input to a trained deep neural network, and determine the outcome prediction based on output of the trained deep neural network.

According to some embodiments, a method includes computationally generating a set of faux stain images of unstained specimens from a cohort of patients and corresponding ground truth predictions, wherein each ground truth prediction is indicative of an outcome for a patient within the cohort associated with one of the faux stain images and dividing the set of faux stain images and corresponding ground truth predictions into a training set and a validation set. The method also includes performing an initial training of a deep neural network by: providing sub-images from a region of interest of a given faux stain image from the training set to the deep neural network, generating an aggregate outcome prediction for the given faux stain image based on outcome predictions associated with each sub-image of the given faux stain image, and updating weights of the deep neural network based on a difference between the aggregate outcome prediction and the ground truth prediction for the given faux stain image. The method also includes performing fine-tuning of the deep neural network using the validation set, wherein the fine-tuning comprises updating at least one hyperparameter.

These and other features and embodiments will be described in more detail with reference to the drawings.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

FIG. 1 is an illustration of an example of two H&E stained microscopy images of non-small cell lung cancer (NSCLC) histologic slides.

FIG. 2 depicts a schematic diagram of components of an ultraviolet-visible-angular ptychographic imaging with closed form solution (UV-Vis-APIC) system, according to embodiments.

FIG. 3A depicts a schematic diagram of a plan view of an illumination device of an UV-Vis-APIC system, according to various embodiments.

FIG. 3B depicts a photograph of an example of an illumination device of an UV-Vis-APIC system, according to an embodiment.

FIG. 4 depicts illustrations of amplitude, phase, and pupil reconstruction of an APIC technique using visible wavelength, according to embodiments.

FIG. 5A depicts a brightfield microscopy image of an H&E-stained NSCLC histology slide.

FIG. 5B depicts a brightfield microscopy image of an unstained NSCLC histology slide, according to an embodiment.

FIG. 5C depicts an example of a faux-stained image of the unstained NSCLC histology slide and a corresponding ultraviolet absorption image and corresponding visible light phase data image, according to an embodiment.

FIG. 6 is an example of an autofluorescence image of an unstained NSCLC slide, according to an embodiment.

FIG. 7 depicts a schematic diagram depicting some of the operations of an APIC technique, according to various embodiments.

FIG. 8 is a flow diagram depicting an example of a stain-free all-in-focus imaging method with multi-spectral imaging, according to various embodiments.

FIG. 9 is a flow diagram depicting operations of APIC reconstruction, according to an embodiment

FIG. 10 is a flow diagram depicting operations of aberration extraction, according to an embodiment.

FIG. 11 is a schematic illustration depicting operations of APIC reconstruction, according to an embodiment.

FIG. 12 illustrates an example system that utilizes deep learning for outcome predictions in accordance with some embodiments.

FIG. 13A is a schematic diagram of components of a system with UV-Vis-APIC and deep learning, in accordance with some embodiments.

FIG. 13B is a schematic illustration of operations for training and validating a deep neural network for outcome predictions using, as input, faux-stained all-in-focus images, according to an embodiment.

FIG. 14 is a flowchart of an example process for generating outcome predictions using a deep neural network in accordance with some embodiments.

FIG. 15 is a flowchart of an example process for training a DNN in accordance with some embodiments.

FIG. 16 illustrates example techniques for generating samples provided as input to a DNN, according to an embodiment.

FIG. 17 illustrates example techniques for generating samples provided as input to a DNN, according to an embodiment.

FIG. 18 illustrates example training techniques for training a deep neural network in accordance with some embodiments.

FIG. 19A depicts a plan view of an example of an illumination device that can be used for darkfield imaging, according to embodiments.

FIG. 19B depicts an isometric view of an example of an illumination device that can be used intensity imaging and/or darkfield imaging, according to embodiments.

FIG. 20 is a side view of components of an example of a stain-free all-in-focus imaging system, according to certain embodiments.

FIG. 21 is a side view of components of an example of a stain-free all-in-focus imaging system, according to an embodiment.

FIG. 22 depicts side view of an example of a stain-free all-in-focus imaging system with laser illumination, according to an embodiment.

FIG. 23 depicts a block diagram of an example of a computing device, according to various embodiments.

FIG. 24 depicts a block diagram of an example of a computing device, according to various embodiments.

The figures and components therein may not be drawn to scale.

### DETAILED DESCRIPTION

Different aspects are described below with reference to the accompanying drawings. In the following description, numerous specific details are set forth in order to provide a thorough understanding of the presented embodiments. The disclosed embodiments may be practiced without one or more of these specific details. In other instances, well-known operations have not been described in detail to avoid unnecessarily obscuring the disclosed embodiments. While the disclosed embodiments will be described in conjunction with the specific embodiments, it will be understood that it is not intended to limit the disclosed embodiments.

Progression of various diseases, such as various types of cancer, is typically predicted by humans, such as pathologists or oncologists. For example, given an incidence of cancer, a pathologist may review biopsy slides and may characterize the tumor as likely to metastasize, or not likely to metastasize. An oncologist may then make treatment determinations based on the likelihood of metastasis. However, predicting disease progression can be difficult and/or inaccurate, which can cause suffering for patients. For example, in an instance in which a tumor is incorrectly predicted as not likely to metastasize, lack of treatment may cause more severe disease, or death. Conversely, in an instance in which a tumor is incorrectly predicted to metastasize, more aggressive treatment may be started, which may produce side effects that could be avoided if it were known prior to aggressive treatment that the tumor is not likely to metastasize.

By way of example, lung cancer is currently the single greatest cause of cancer mortality in the United States. Despite advances in therapies, metastasis remains a significant cause of mortality in non-small cell lung cancer (NSCLC) patients. Nearly 50% of early-stage NSCLC patients will develop metastases during the course of their disease. Adjuvant chemotherapy can increase survival in those at risk for developing metastasis but is associated with significant adverse effects, including increased risk of subsequent cancers, reduced lifespan, nerve damage, cardiovascular toxicity, infertility, and immune suppression. Oncologists often stay on the conservative side, treating early-stage patients with adjuvant therapy rather than risking under-treatment, as there are no accepted histologic or molecular biomarkers that can identify those patients who will or will not progress to metastatic disease. The availability of sensitive and specific metastasis prediction tools could significantly improve therapy guidance and lead to healthcare cost-savings while saving patients from unnecessary treatment.

The last decade has witnessed the emergence in artificial intelligence (AI) for pathology due to the rapidly growing field of AI as well as developments in microscopic and computational techniques. Machine learning models such as deep neural networks (DNNs) have been trained on digitized microscopic images to try to accomplish various tasks including cancer grading, segmentation, etc. In some cases, machine learning models have been used to identify subtle features that may predict metastasis. For example, a deep neural network (DNN) may be trained to identify, within a microscopic image provided as input, features that may correlate with tumor metastasis. However, artificial intelligence and neural networks, as have been conventionally implemented thus far, rely on training with images of chemically stained specimens to identify regions that correlate with tumor metastasis.

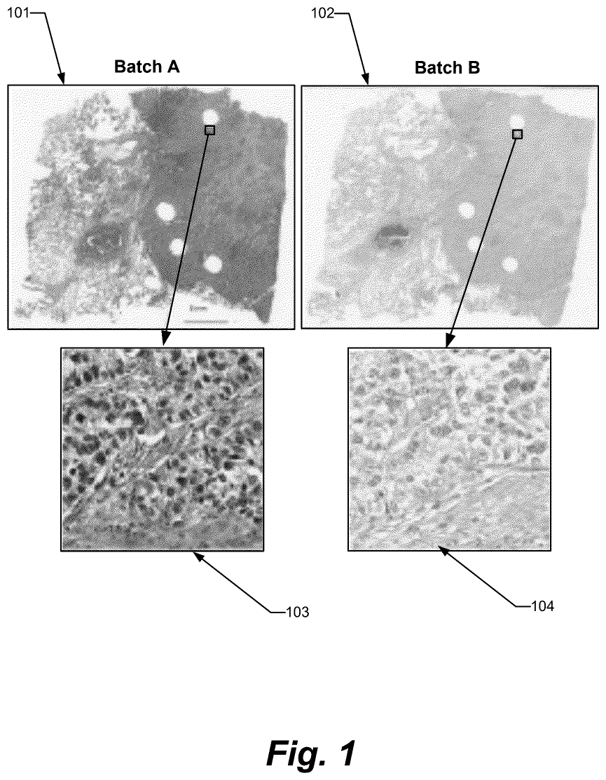

To help image samples that would otherwise be mainly transparent to visible light under a microscope, traditionally, samples are chemically stained so that different structures appear in different colors. Hematoxylin-and-Eosin (H&E) staining is among the most widely used chemical staining techniques used in processing histological slides for digital pathology. H&E staining can provide color contrast between nucleic acids and the extracellular matrix. However, it is difficult to control the concentration of H&E dye solutions, which are typically prepared at different times in separate batches. This results in significant color variations in the histological images even when the same staining protocol is used. For example, FIG. 1 illustrates an example of two microscopy images 101, 102 of non-small cell lung cancer (NSCLC) histologic slides of adjacent tissue slices (a few microns apart) of the same tissue block from the same patient. Also included are two zoom-in regions 103, 104 showing portions of microscopy images 101, 102, respectively. Microscopy image 101 was H&E stained with a dye solution of Batch A, and microscopy image 102 was H&E staining with a dye solution of Batch B prepared at a different time than the dye solution of Batch A. The same staining protocol was used to stain both adjacent tissue slices. As shown, there are significant color variations between the microscopy images of specimens prepared with dye solutions of the different batches, Batch A and Batch B.

The inconsistent colors in chemically stained histological images can bias AI performance and other analyses. Inherent variability in processing tissue specimens and preparing the histological slides, in particular, the tinctorial variations from chemical staining and the inherent unevenness in histological slide preparations leading to out-of-focus areas in the images are the primary sources of AI bias. Due to color variations, trained deep neural networks (DNNs) may have difficulty in generalizing to digital images of chemically stained slides that are processed at different times.

One method for reducing AI bias from staining variations is to use extremely large training datasets (e.g., over ten thousand gigapixel whole slide images) with a variety of color variations so that the AI will eventually learn to ignore this factor and focus on the predictive features. Examples of methods that use large training datasets are found in Chen, R. J., Ding, T., Lu, M. Y. et al. “Towards a general-purpose foundation model for computational pathology,” Nat Med 30, 850-862 (2024) and Richard J. Chen, Chengkuan Chen, Yicong Li, Tiffany Y. Chen, Andrew D. Trister, Rahul G. Krishnan, Faisal Mahmood; Proceedings of the IEEE/CVF Conference on Computer Vision and Pattern Recognition (CVPR), pp. 16144-16155 (2022) However, such large datasets may not be feasible to obtain, or can be excessively expensive to collect, especially for specific clinical tasks. Another method of reducing AI bias is to create generative faux-stain images with data collected from unstained slides using generative AI, such as generative adversarial neural networks (GANs), in which the networks are trained with paired unstained data as well as the chemically stained images as the ground truth. However, such generative faux-stain images are often subject to model hallucination and thus are generally not useable since even a tiny artifact is not tolerated for pathology applications. In addition, such artifacts impact downstream analysis.

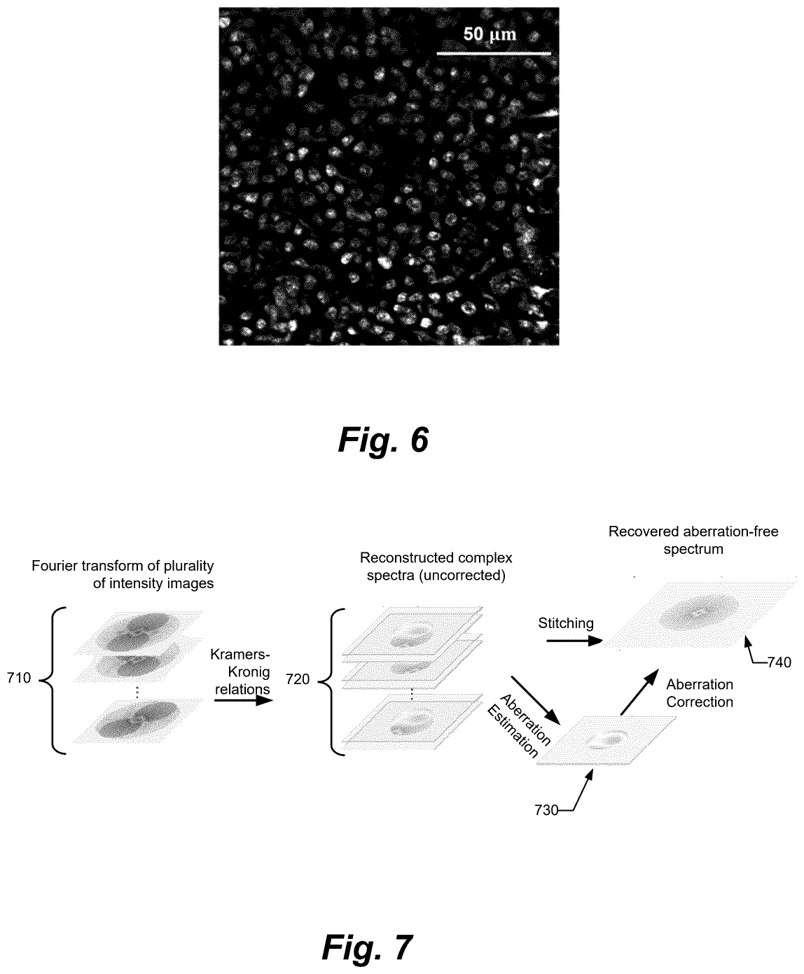

Disclosed herein are techniques that avoid chemical staining of specimens and generative faux staining, and instead use stain-free (non-staining) microscopy techniques that use information from raw images of unstained specimens to computationally generate faux-stained images. These stain-free microscopy techniques can avoid the variability in images from conventional chemical staining histology that might introduce AI bias. The faux-stained images computationally generated by the imaging system can be used as input to a machine learning model (e.g., DNN) for training and analysis. In certain cases, these stain-free microscopy techniques involve intensity imaging to capture raw intensity measurements indicative of light absorbed by the unstained specimen to determine preferential absorption by different components to reveal intrinsic contrasts. For instance, deep ultraviolet (DUV) light has preferential absorption by nucleic acid contents, and measurements indicative of DUV light absorbed by the unstained specimen can be used to provide nucleic contrast. It should be noted that absorption may vary under different illumination wavelengths. DUV is electromagnetic radiation with a wavelength in the range between 200-300 nm. However, if the unstained sample is illuminated with visible light (wavelength in the range of 400-700 nm), the intensity measurement indicative of the sample absorption will show little to no contrast, as the unstained samples are mostly transparent to visible light with little absorption. Phase imaging, on the contrary, reveals tissue structural content with measurements indicative of the refractive index distribution across the specimen. In one embodiment, both phase imaging based on visible light illumination and intensity imaging based on DUV illumination are used to determine both chemical content and structural content. In addition or alternatively to other imaging methods, darkfield imaging may be used to enhance sample contrast by only using the scattered optical signals. In other cases, the techniques involve polarization imaging and/or birefringence imaging may be used. In polarization imaging, the polarization properties of the measurements of polarized light issuing from the unstained specimen can be used to reveal information about the structure and properties of the unstained specimen, particularly in anisotropic biomaterials. In an imaging system configured for polarization imaging, a set of polarization filters is placed before the light detector(s). In addition, autofluorescence imaging may be used to reveal chemical and structural content from natural fluorophores within unstained specimens. Specifically, different wavelengths of light may be used to illuminate the unstained specimen to elicit the spontaneous emission of light from natural fluorophores in NADH, collagen, flavins, etc. This can, in turn, reveal the respective chemical and structural information in the sample. In an imaging system configured for autofluorescence imaging and UV intensity imaging, optical filters will be placed in the optical paths to separate the illumination and autofluorescence light of various wavelengths. FIG. 6 is an example of an autofluorescence image of an unstained NSCLC slide that was illuminated by excitation light of a wavelength of 365 nm where the emissions from the specimen fluorophores captured by the light detectors had a wavelength between 400 nm and 700 nm. Employing autofluorescence imaging may advantageously provide more detail of chemical information than with the standard UV intensity measurements. In addition to other imaging methods, fluorescence lifetime imaging may be used to employ the decay of the fluorescence signal from the unstained specimen to reveal chemical and structural information with a high-speed camera (e.g., single-photon avalanche diode array camera with a frame speed greater than 10,000 fps).

As used herein, a “raw stain-free image,” “raw stain-free specimen image,” or “raw stain-free sample image” generally refers to a raw intensity image of an unstained specimen captured under a microscope by one or more light detectors (e.g., of a camera) such as CMOS sensors. An “unstained specimen” refers to a specimen (e.g., tumor or other tissue biopsy, or other tissue sample) that has been prepared for microscopy imaging without the use of chemical staining. The unstained specimen may be prepared on a specimen slide, a dish, a specimen plate, or other suitable receptacle capable of being placed under the microscope for imaging.

In certain embodiments, microscopy images may be “faux stained” using computational techniques, which are generally referred to herein as “faux-stained images.” In various examples, computational techniques may be used to generate a faux-stained image from one or more raw stain-free microscopy images or one or more raw stain-free microscopy images that have been digitally processed to determine amplitude, phase, autofluorescence, polarization, multi-spectra information. For example, in certain embodiments, a faux-stained image is produced, using computational techniques (e.g., APIC techniques discussed in Section II), from one or more stain-free raw microscopy images of an unstained specimen illuminated by a first wavelength and one or more stain-free microscopy images of the unstained specimen illuminated by a second wavelength under the microscope. In one example, a faux-stained image is produced by combining a visible light phase image produced in part using an APIC technique with a UV absorption image.

Disclosed herein are techniques for multi-spectral microscopy imaging that obtain raw stain-free images of an unstained specimen illuminated by different wavelengths of light and use information from the information from the raw stain-free images and/or digitally processed stain-free images to generate the faux-stained images with contrast for identifying respective information corresponding to the different wavelengths. For example, the faux-stained images may include chemical information that can be used to detect nucleic acids and structural information of, for instance, the extracellular matrix and other structures surrounding cells. As another example, the faux-stained images may include structural information and information indicative of the material properties of the unstained specimen.

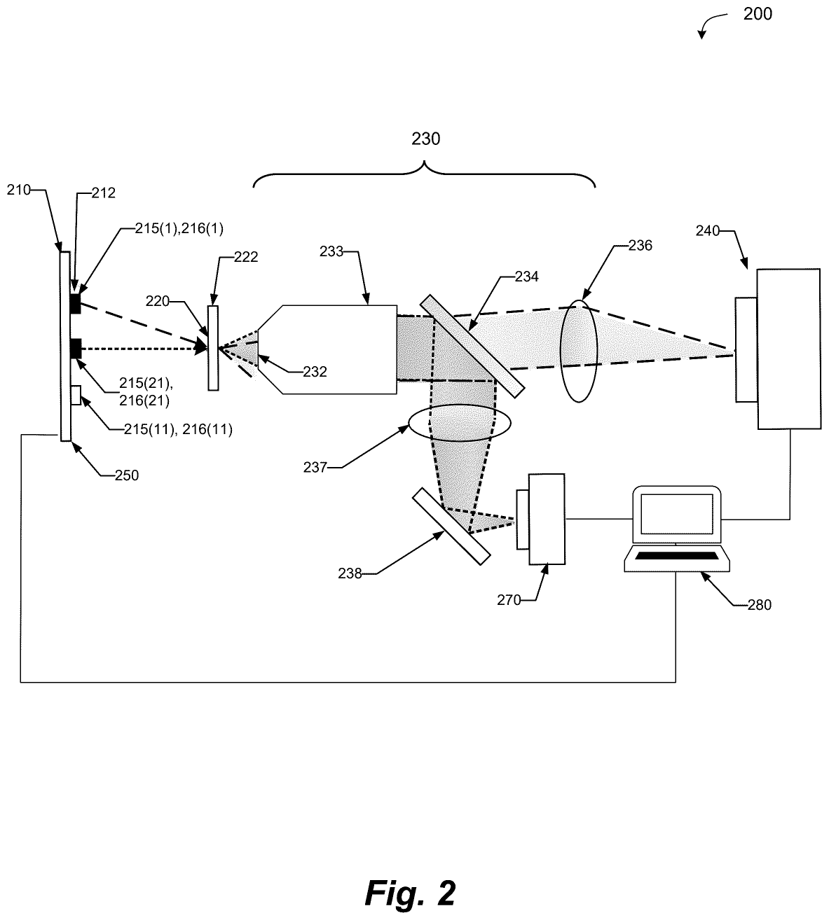

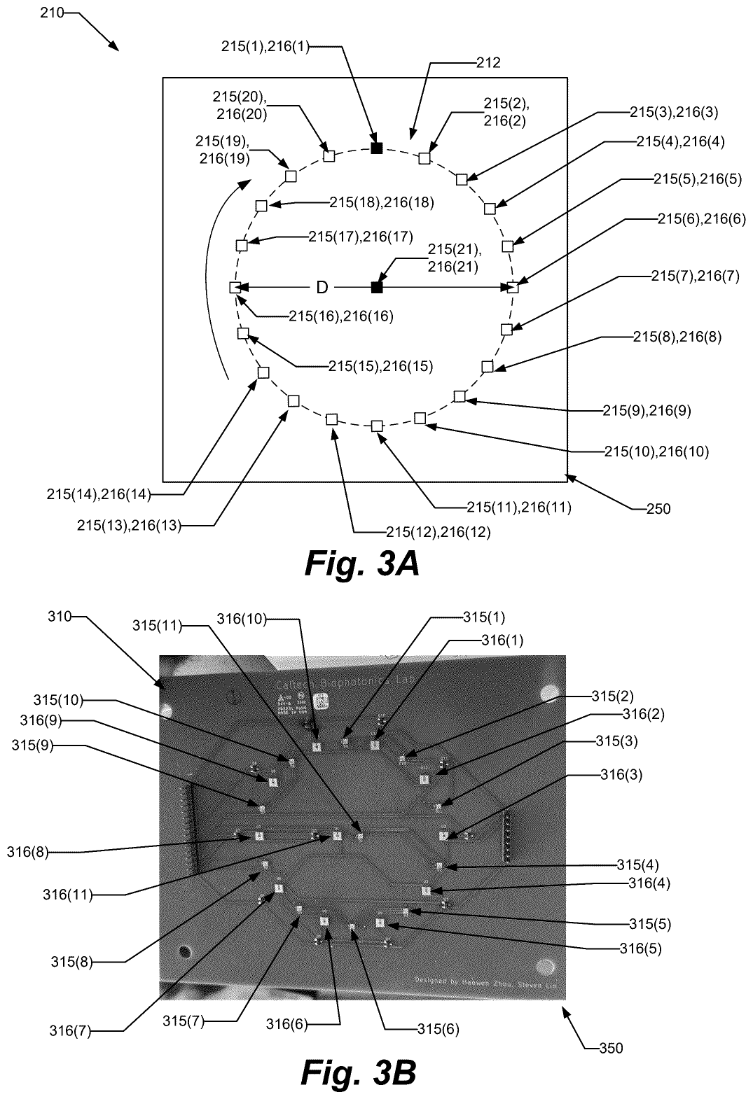

In some cases, these techniques include a stain-free all-in-focus imaging system with multi-spectral illumination. For example, a stain-free all-in-focus imaging system may include one or more first light sources for emitting light of a first wavelength and one or more second light sources for emitting light of a second wavelength (multi-spectral). In some of these cases, the one or more first second sources emit ultraviolet light to illuminate the unstained specimen and intensity measurements of ultraviolet light transmitted through the unstained images are captured. The intensity measurements are indicative of the ultraviolet light absorbed by the unstained specimen which may be used to determine chemical content in the specimen. For example, the contrast in intensity measurements of DUV light transmitted through an unstained specimen arises from preferential absorption of DUV by chemical contents such as nucleic acids. The measurements indicative of DUV light absorbed by the unstained specimen can be used to determine nucleic acid content. In certain aspects, DUV light employed has wavelength in a range between 250-300 nm. In one aspect, DUV light employed has wavelength in a range between 250-280 nm. In addition or in the alternative, the first light sources may emit visible light (e.g., light with wavelength in range of 400 nm-700 nm) to illuminate the unstained specimen at a sequence of oblique angles (e.g., a plurality of angles matching the acceptance angle of the collection objective) and intensity measurements of visible light transmitted through the unstained images are captured. The intensity measurements can be used to determine phase information to generate a phase image. For example, APIC techniques described in Section II may be used to generate a phase image. The contrast in the phase image is indicative of structural content. An example of a stain-free all-in-focus imaging system that includes one or more first light sources that emit visible light (e.g., visible light sources 215 in FIGS. 2 and 3A) and one or more second light sources that emit ultraviolet light (e.g., ultraviolet light sources 215 in FIGS. 2 and 3A) is UV-Vis-APIC system 200 shown in and described with reference to FIG. 2.

In various embodiments, computational techniques are used to generate all-in-focus faux-stained images. Generating all-in-focus faux-stained images avoids blurry images being used as input to a machine learning model (e.g., DNN) or the need to remove blurry images from the dataset used to train the machine learning model. For phase imaging, APIC techniques described in Section II can be used to generate an all-in focus phase image that can be used as a faux-stained image or can be combined with one or more other all-in-focus images to generate a faux-stained image. In some cases, such as with ultraviolet transmission examples, generating images that are all-in-focus can be accomplished by autofocusing techniques that integrate an absolute metric such as an absolute central momentum, Laplacian operator, tenegrad, a binary/exponential search algorithm, and an axial scanning module. The image can be acquired at two axial planes at first and compute a metric to evaluate the focus quality subsequently. From the two metrics computed a binary/exponential search algorithm will be implemented to obtain a focus image. These techniques can rapidly bring the sample into focus to eliminate out-of-focus images while speeding up the acquisition process.

### Sample/Specimen Preparation Protocol

Sample preparation processes do not generally have a standard protocol that is applied across different lab facilities. In addition, intrinsic variations (e.g., concentrations) in the dye solutions might affect staining results, leading to extraneous variations. Just as it takes an AI model fewer examples to recognize typeset characters than handwritten characters, controlling the preparation and imaging process will lead to a more well-controlled setting that allows the reduction of the size of the dataset for effective AI model training.

Disclosed herein are techniques (protocol) for preparing samples for transmission imaging with ultra-violet (DUV) illumination (e.g., light with wavelength in range of 200-300). For example, a certain preparation protocol involves controlling sample storage, the deparaffinization process, and the microtoming process. The sample is deparaffinized, microtome and dehydrated with standard traditional pathology standards. But no histology staining is involved in this process. The mounting media, such as, glycerol, AquaMount, phosphate-buffered saline, can be used to mount the sample on a quartz slide.

These techniques can standardize the specimen preparation process which avoids variations in specimen slides which can generate uniform quality stain-free microscopy sample images for input into AI models. In various embodiments, the imaging techniques described herein may be used to image fixed tissue sections on a slide or other receptacle. In other embodiments, the imaging techniques may be used to image fresh tissue sections, biopsy preps, and liquid-based samples such as a sample in a liquid (e.g., blood, urine, saliva, etc.) on a microscope slide or other receptacle which avoids fixation related variability from the process.

### Machine Learning Models

In some cases, the techniques disclosed herein include training a machine learning model (e.g., DNN) to generate outcome predictions associated with an input microscopy image such as a faux-stained image. For example, the microscopy image may correspond to a tumor biopsy or other tissue biopsy. The machine learning model may be configured to generate a prediction of an outcome for the patient associated with the microscopy image. The outcome may correspond to a prediction of disease progression, for example, that a tumor may metastasize from the region of biopsy to a second body region, that death may occur within a given time window, that a cancer may go from early stage to invasive, or the like. Alternatively, the outcome may be a prediction associated with the patient's state or health in the future, e.g., within a given time window. For example, the outcome may correspond to a prediction of the likelihood the patient will respond to treatment or the likelihood that the patient will experience certain side effects due to the disease or the treatment. Note that the machine learning model may make a prediction without explicitly identifying regions or features of interest within the microscopy image.

In some embodiments, a region of interest within a microscopy image may be identified. The region of interest may correspond to a tumor or a portion of a tumor, a region in the microenvironment of the tumor, or the like. The region of interest may be sampled to generate a set of sub-images. The number of sub-images may be, e.g., ten, one hundred, one thousand, ten thousand, etc. Note that while a whole slide microscopy image may be on the order of gigapixels, each sub-image may be thousands or tens of thousands of pixels, enabling faster inference time by the machine learning model. The machine learning model may generate an outcome prediction for each sub-image, which may be a continuous value, e.g., between −1 and 1, between 0 and 1, etc. The outcome prediction may indicate a likelihood of a particular outcome, such that the tumor will metastasize. The outcome predictions associated with sub-images of the set of sub-images may be aggregated to generate an aggregate outcome prediction. For example, in some embodiments, the aggregate outcome prediction may be a median of the outcome predictions associated with the sub-images. In some embodiments, a threshold may be applied to the aggregate outcome prediction to generate a final classification, e.g., that a tumor will metastasize.

Using the techniques disclosed herein, outcome predictions for disease progression may be substantially improved relative to conventional techniques that involve a pathologist or a machine learning model identifying features of interest in a microscopy image, and subsequently having a pathologist classify progression risk based on the features of interest. The improved performance of the machine learning model may lead to improved treatment of patients by correctly providing aggressive treatments for patients at high risk for disease progression, and by avoiding aggressive treatment (which may come with severe side effects) for patients at low risk for disease progression.

In some embodiments, microscopy images may be digitally focused using computational techniques such as APIC methods. This may allow for post-imaging digital refocusing. Example techniques for performing APIC which may be used to digitally refocus microscopy images are described in Cao, R., Shen, C. & Yang, C. High-resolution, large field-of-view label-free imaging via aberration-corrected, closed-form complex field reconstruction. Nat Commun 15, 4713 (2024), which is hereby incorporated by reference in its entirety. In other words, in various embodiments, a microscopy image provided to a machine learning model as an input image is a faux-stained image or a digitally-refocused faux-stained image. Some examples of APIC techniques are also described in Section II.

As discussed in Lin, S., Zhou, H., Watson, M. et al., “Impact of stain variation and color normalization for prognostic predictions in pathology,” Sci Rep 15, 2369 (2025), it has been shown that for a small training dataset, AI models are prone to extraneous variations in the dataset due to staining/prep process of the samples. In certain embodiments, the methods for preparing specimens discussed above are implemented for a more consistent sample preparation process that ensures uniform high quality microscopy images are generated so that the AI (machine learning, deep learning) models will need a smaller training dataset to make predictions/decisions.

For example, certain techniques disclosed herein include UV-Vis-APIC imaging systems and imaging methods that implement specimen slides that are prepared by the methods for preparing specimens for transmission imaging with deep ultra-violet (DUV) illumination described above. These techniques advantageously implement this standardized process for preparing specimens for microscopy imaging that can avoid process variability to generate uniform quality microscopy images (e.g. faux-stained all-in-focus images). These uniform quality microscopy images can be used as input into AI models, such as deep neural networks, to make outcome predictions. With this more consistent data preparation, the AI (machine learning, deep learning) will need a smaller training dataset to train the AI model to make predictions/decisions.

In certain embodiment, machine learning models such as DNNs are trained with training datasets of faux-stained images generated by, for example, an UV-Vis-APIC system. These faux-stained images are not conventional images typically used by pathologists or clinicians, but are useful as input to AI models given data consistency. In some cases, the machine learning models may identify features in the faux-stained images that are treated as useful input for making predictions, but are unfamiliar to pathologists and clinicians. Moreover, humans generally rely heavily on prior knowledge or experience, tending to look for familiar patterns or features to make predictions. In contrast, a well-trained machine learning model can learn to look for predictive features without much prior knowledge.

### I. Stain-Free All-in-Focus Imaging Systems

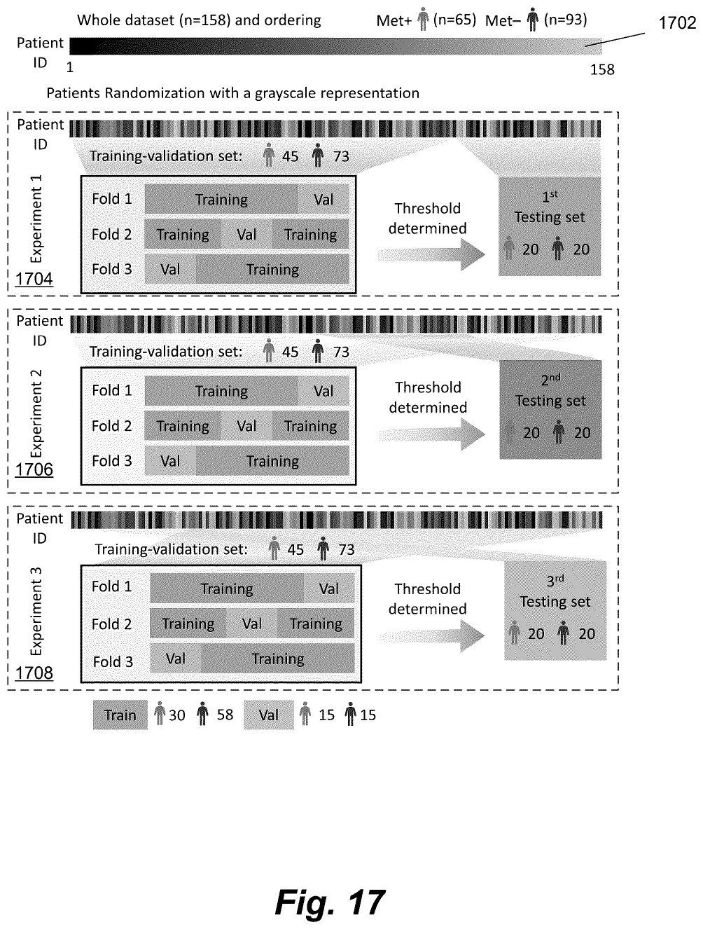

Certain techniques disclosed herein include stain-free all-in-focus imaging techniques that can sample raw stain-free images of an unstained specimen and use computational methods to generate faux-stained all-in-focus images. Each stain-free all-in-focus imaging system includes at least one computing device. Components of the computing device(s) and/or an external computing device may be used to utilize a trained DNN at inference time, and/or to train a DNN. In some cases, these techniques include microscopy techniques that incorporate multi-spectral imaging to, for example, simultaneously provide nucleic specificity similar to H&E staining as well as structural contrast of cells in the form of a faux stained image. The faux-stained all-in-focus images are physics-based and are highly consistent and ready to be used for downstream Al analysis. One example of such a microscopy system with multi-spectral imaging is an ultraviolet-visible-angular ptychographic imaging with closed form solution (UV-Vis-APIC) system. Other examples of microscopy techniques with multi-spectral imaging are shown in and described with reference to FIGS. 17-21.

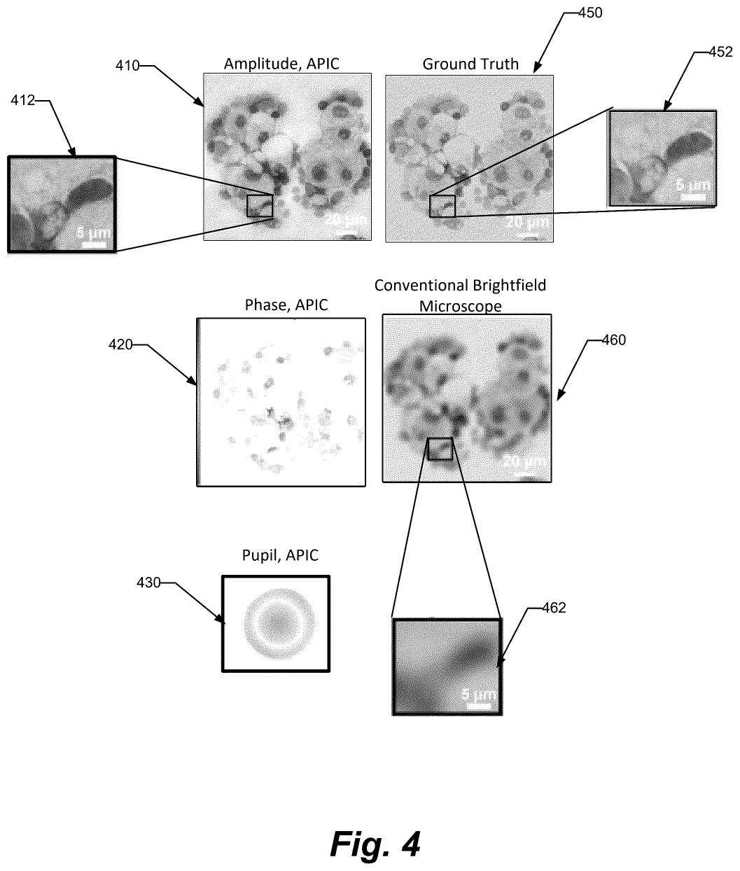

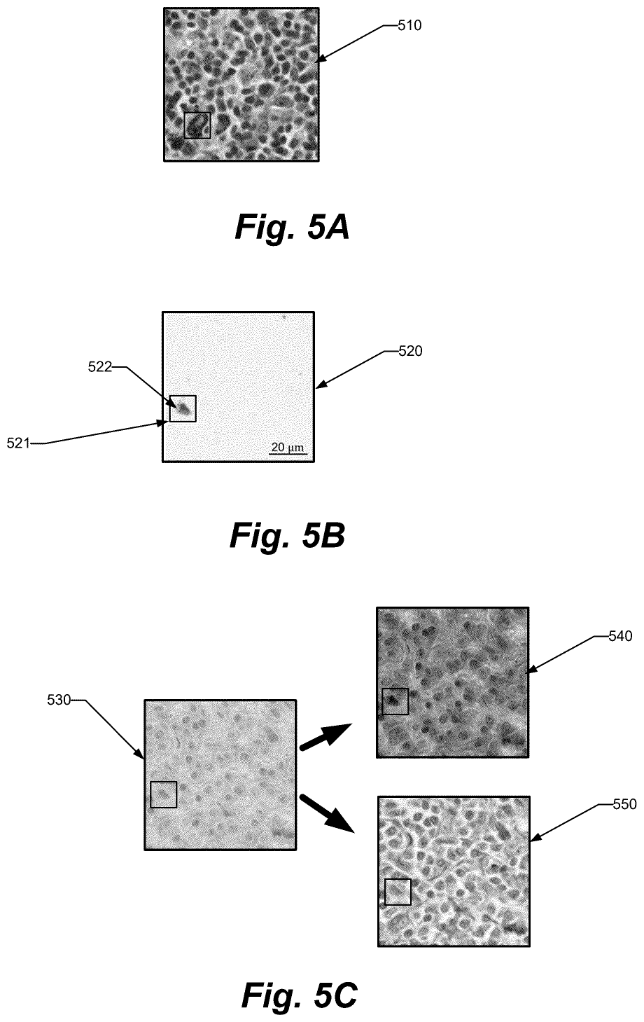

UV-Vis-APIC systems and certain other stain-free all-in-focus imaging systems with multi-spectral imaging utilize the specimen absorption of light at one wavelength as well as refractive index information from light at another wavelength at a sequence of oblique illuminations. The APIC technique can be used to analytically retrieve the refractive index information from the raw intensity images captured during a sequence of oblique illuminations. UV-Vis-APIC systems use ultraviolet light, such as deep ultraviolet (DUV) light at a wavelength in the range of 260-270 nm (e.g., 265 nm wavelength) to provide nucleic acid information since nucleic acids have high absorption in the wavelength spectrum of 260-270 nm. UV-Vis-APIC systems take at least one intensity measurement indicative of ultraviolet light absorbed by the unstained specimen (UV absorption image(s)). The visible light illuminations at a sequence of oblique angles are used to encode the relative refractive index across the unstained specimen into optical phase to provide cell structural information. The APIC technique is used to reconstruct the optical field from the raw intensity images captured during the oblique illuminations, and the phase information retrieved during APIC reconstruction can be used to generate a visible light phase image. UV-Vis-APIC systems combine the UV absorption image with the visible light phase image to generate a faux stain image (e.g., faux-stained image 530 in FIG. 5C). These faux-stained images avoid the staining variations discussed above while producing rich cellular detail. The APIC technique allows for analytical retrieval of optical aberrations, which frees stain-free all-in-focus imaging systems from cumbersome z-scanning or refocusing to account for sample unevenness or tilted displacements as well as aberrations associated with system optics (e.g., UV optics) as described below with reference to FIG. 4. After data acquisition, the aberration can be corrected in the APIC optical field reconstruction process to achieve all-in-focus, aberration-free faux-stained images of, for example, the entire sample slide. Resulting faux-stained images are reliable and consistent. With the high-quality and tightly controlled slide preparation (e.g., using protocol discussed above) and/or the stain-free all-in-focus imaging methods, the downstream AI analysis is more stable and generalizable while requiring less data (e.g., smaller training dataset) as there are fewer factors that might bias the AI models.

### UV-Vis-APIC System

In various embodiments, UV-Vis-APIC systems use an APIC technique in which the unstained specimen's absorption information as well as refractive index information can be retrieved analytically from raw intensity images captured during a sequence of oblique illuminations of visible light and ultraviolet light. Examples of APIC techniques that can be utilized are described in Section II.

FIG. 2 depicts a schematic diagram of components of an UV-Vis-APIC system 200, according to embodiments. UV-Vis-APIC system 200 includes an illumination device 210, an optical system 230, a visible light detector 240, and an ultraviolet light (second) detector 270, and a computing device 280 in electrical communication with visible light (first) detector 240, ultraviolet light detector 270, and illumination device 210. FIG. 3A depicts a schematic diagram of a plan view of the illumination device 210. Optical system 230 includes an aperture 232, an objective 233, a harmonic beam splitter 234, a first focusing lens 236, a second focusing lens 237, and a mirror 238. Harmonic beam splitter 234 is configured to separate visible light from ultraviolet light in light received from the objective 233, passing the visible light to first focusing lens 236 and reflecting ultraviolet light to second focusing lens 237. The ultraviolet light focused by the second focusing lens is reflected by mirror 238 to ultraviolet light detector 270. In one aspect, the objective 233 is a low magnification objective such as a 10x magnification, NA 0.25 objective. The UV-Vis-APIC system 200 is shown during an imaging process in which a specimen holder 222 with an unstained specimen 220 disposed thereon is located between the objective 233 and the illumination device. In one aspect, the illumination device 110 includes a diffusing material in front of the ultraviolet light sources 216 at least when acquiring the UV image in order to provide more uniform brightfield illumination.

Illumination device 210 (e.g., light emitting diode (LED) array) includes a printed circuit board 250 with a ring 212 of twenty (20) visible light sources 215(1)-(20) (e.g., RBG LEDs) and ultraviolet light sources 216(1)-(20) (e.g., UV LED), and a center visible light source 215(21), and a center ultraviolet light source 215(21) mounted thereon. The ring 212 has a diameter, D. In one implementation, the geometric center of each of the visible light sources 215(1)-(20) and each of the ultraviolet light sources 216(1)-(20) is located along the ring 212 and/or the visible light sources 215(1)-(20) have equal spacing and the ultraviolet light sources 216(1)-(20) have equal spacing between adjacent light sources. In the illustrated example, the geometric center of center ultraviolet light source 216(21) and center visible light source 215(21) is located at the center of the ring 212. It is contemplated that the visible light sources 215 and/or the ultraviolet light source 216 may have different positions in other implementations.

The illumination device 210 is configured to activate the visible light sources 215(1)-(21) in sequence (e.g., in clockwise direction of curved arrow shown in FIG. 3A) to emit light at a respective plurality of illumination angles to a surface of the specimen holder 222 with the unstained specimen 220 being imaged. The illumination device 210 is also configured to activate one or more of the ultraviolet light sources 216(1)-(21) to emit light at a respective plurality of illumination angles to the surface simultaneously or in sequence. In one implementation, the diameter, D, of the ring 212 and the distance between the ring 212 and a surface of the specimen holder 222 may determine the illumination angles of visible light sources 215(1)-(20) and ultraviolet light sources 216(1)-(20). The illumination angles of ultraviolet light source 216(21) and visible light source (21) are about 90 degree with respect to the surface of the specimen holder 222.

In various implementations, the illumination device 210 is designed and located such that the illumination angles are equal to, or nearly equal to, the maximum acceptance angle of objective 233 (NA-matching illumination angles). The illumination device 210 is configured to activate at least one of the ultraviolet light sources 216 to emit ultraviolet light while at least one of the visible light sources 215 is illuminated. FIG. 3A depicts a first visible light source 215(1) emitting visible light during which the visible light detector 270 takes a measurement. FIG. 3A also depicts a first ultraviolet light source 215(2) emitting ultraviolet light during which the ultraviolet light detector 240 takes a measurement. The illumination device 210 may include additional or fewer visible light sources 215 and/or ultraviolet light sources 216 in other implementations. Also, the visible light sources 215 and/or ultraviolet light sources 216 may be illuminated in different orders (e.g., random order, counterclockwise direction, etc.) according to various implementations.

The computing device 280 is in electrical communication with visible light detector 240 and the illumination device 210 in order to synchronize the activation of visible light sources 215 to emit visible light illumination sequentially at different illumination angles with the exposure times of the visible light detector 240 in order to take intensity measurements that capture a plurality of raw intensity images indicative of visible light transmitted through the unstained specimen 220 at the respective plurality of illumination angles. The computing device 280 is in electrical communication with ultraviolet light detector 270 and the illumination device 210 to synchronize the activation of one or more of the ultraviolet light sources 216 to emit ultraviolet light during an exposure time of the ultraviolet light detector 270 to take one or more intensity measurements to capture an intensity image indicative of ultraviolet light absorbed by the unstained specimen 220. In one case, all the ultraviolet light sources 216 are illuminated while an UV absorption image is captured. In some cases, the computing device 280 may be configured to send control signals to synchronize image acquisition by visible light detector 240 and/or ultraviolet light detector 270 with activation of different light sources 215, 216 of the illumination device 210. The computing device 280 may also receive signals with intensity measurement data from visible light detector 240 and/or perform other functions of the APIC system such as reconstruction process. Although various examples describe capturing one light intensity measurement indicative of ultraviolet light absorbed by the unstained specimen 220, it is contemplated that additional intensity measurements may be captured according to other implementations.

In FIG. 2, UV-Vis-APIC system 200 has components arranged in a transmission mode where light transmitted through unstained specimen 220 is received at the optical system 230. In another implementation, UV-Vis-APIC system 200 may have components arranged in reflection mode where light reflected from the unstained specimen 220 is received at optical system 230, which may be advantageous for use in imaging thick specimens. For example, illumination device 210 may be located on the opposite side of specimen holder 222.

FIG. 3B depicts a photograph of an example of an illumination device 310, according to an embodiment. Illumination device 210 (e.g., light emitting diode (LED) array) includes a printed circuit board 350 with a ring of ten (10) visible light sources 315(1)-(10) (e.g., RBG LEDs), a central visible light source 315(11), a ring of (10) ultraviolet light sources 316 (e.g., UV LED), and a central ultraviolet light source 316(11) mounted thereon.

In various embodiments, the illumination device of a Stain-Free All-in-Focus Imaging system includes a plurality of light sources (e.g., visible light sources and/or ultraviolet light sources) that are configured to emit light sequentially at a plurality of illumination angles to the unstained specimen being imaged where the plurality of illumination angles are equal to, or nearly equal to, the maximum acceptance angle of collection optics (e.g., objective 233 in FIG. 2). In some cases, the visible light sources are configured to provide light in a range of 400-700 nm. In certain implementations, each of the visible light sources is an RGB LED. The illumination device also includes at least one ultraviolet light source (e.g., ultraviolet LED). In some cases, the at least one ultraviolet light source is a light source of deep ultraviolet (DUV) light. For example, the at least one ultraviolet light source may be a source of DUV light with a wavelength in a range between 250-300 nm. In another example, the at least one ultraviolet light source may be a source of DUV light with a wavelength in a range between 250-280 nm. In another example, the at least one ultraviolet light source may be a source of DUV light with a wavelength of about 265 nm.

In some cases, the visible light sources 215 may be a source of visible light with wavelength in a range of 400-700 nm. The visible light sources 215 may be RGB LEDs, for example. Visible light can be used to encode the relative refractive index across the unstained specimen 220 into optical phase to provide cell structural information. For example, the intensity measurements taken by the visible light detector 240 can be used to generate a phase image which has information indicative of structural information. The phase image can be computationally determined using an APIC technique, for example.

In some cases, the ultraviolet light source 216 may be a source of DUV light. The intensity measurements taken by the ultraviolet light detector 270 are indicative of DUV light absorbed by the unstained specimen 220, which can be used to determine chemical content such as nucleic acid content. For example, the ultraviolet light source 216 may be a source of DUV light with wavelength in a range between 250-300 nm. In another example, the ultraviolet light source 216 may be a source of DUV light with wavelength in a range between 250-280 nm. In another example, ultraviolet light source 216 may be a source of DUV light with a wavelength of about 265 nm. Employing an ultraviolet light source 216 emitting ultraviolet (UV) light at 265 nm wavelength may be particularly advantageous by providing nucleic acid information in the raw intensity image as nucleic acids have high absorption in the wavelength spectrum of 260-270 nm.

The UV-Vis-APIC system 200 can be used to perform operations of a stain-free all-in focus imaging method to generate a faux-stained image. For instance, in an exemplary stain-free all-in focus imaging method, the UV-Vis-APIC system 200 can cause visible light to be emitted by visible light sources 215 sequentially at a plurality of illumination angles and cause ultraviolet light to be emitted by one or more of the ultraviolet light sources 216 in order to illuminate the unstained specimen 220 with visible light and ultraviolet light. In one instance, the unstained specimen 220 is illuminated simultaneously with visible light and ultraviolet light. In another instance, the unstained specimen 220 is illuminated with ultraviolet light at a separate time. In some cases, the ultraviolet light source 216 is operable to emit DUV light with wavelength in a range between 250-280 nm such as a wavelength of about 265 nm. The harmonic beam splitter 234 passes the visible light to first focusing lens 236 and reflects the ultraviolet light to second focusing lens 237. The visible light detector 240 takes a plurality of first intensity measurements of visible light while the visible light sources 215 emit visible light at respective plurality of illumination angles. Each first intensity measurement is taken during illumination at one of the illumination angles. The ultraviolet light (second) detector 270 takes a second intensity measurement (also sometimes referred to as a UV absorption image) while the ultraviolet light source 216 emits ultraviolet light. The stain-free all-in focus imaging method uses an APIC technique to reconstruct a phase image from phase information recovered from the plurality of second intensity measurements. During the APIC optical field reconstruction process, aberration can be retrieved and corrected to produce an all-in-focus aberration-free phase image. The stain-free all-in focus imaging method combines the UV absorption image with the phase image to form a faux-stained image.

It should be noted that the components of UV-Vis-APIC system 200 may be located in different positions and/or the UV-Vis-APIC system 200 may have different, fewer, or additional components according to other implementations. For example, in other implementations UV-Vis-APIC system 200 may have different, fewer, or additional components to enable darkfield imaging, polarization imaging, birefringence imaging, autofluorescence imaging, and/or fluorescence lifetime imaging. These can be achieved with the laser/LED illuminations, polarizers an a waveplates, bandpass optical filters, and regular or polarization cameras.

FIG. 5A depicts a brightfield microscopy image 510 of an H&E-stained NSCLC histology slide. FIG. 5B depicts a brightfield microscopy image 520 of an unstained NSCLC histology slide. The brightfield microscopy image 520 includes an area 521 with a carbonized region 522 that appears darker than other portions of the image. Carbonized regions are characteristic of a smoker's lung tissue. FIG. 5C depicts an example of a faux-stain image 530 of the unstained NSCLC histology slide and a corresponding ultraviolet absorption image 540, and a corresponding visible light phase data image 550, according to an embodiment. The faux-stain image 530 was generated by the UV-Vis-APIC system 200 shown in and described with reference to FIG. 2. The method 800 described shown in and described with reference to FIG. 8 was used to generate the faux-stained image. As can be seen, the ultraviolet absorption image 540 includes details of the nucleic content and the visible light phase data image 550 includes details of the extracellular structural content. The faux-stained image 530 includes the image data of both the ultraviolet absorption image 540 and the visible light phase data image 550. The produced faux-stained images have rich cellular detail while avoiding chemical staining and associated variations across batches that might introduce AI bias.

FIG. 4 depicts illustrations of amplitude, phase, and pupil reconstruction with an APIC technique using visible wavelength on a human thyroid carcinoma cell sample and comparison against bright field images, according to embodiments. FIG. 4 includes an amplitude image 410 of the human thyroid carcinoma cell sample, a phase image of the human thyroid carcinoma cell sample, and an illustration of a pupil reconstructed using APIC technique. Also shown are ground truth image 450 and conventional brightfield microscope image 460. In addition, shown are enlarged image 412 of amplitude image 410, enlarged image 452 of ground truth image 450, and enlarged image 462 of conventional brightfield microscope image 460.

### II. Stain-Free All-in-Focus Imaging Methods

Certain techniques disclosed herein include stain-free all-in-focus imaging methods. One or more operations of these methods may be performed by a stain-free all-in-focus imaging system such as UV-Vis-APIC system 200 in FIG. 2 any of the systems 1700, 1800, 1900, 2000, 2100, and 2200, shown in, and described with reference to, FIGS. 17, 18, 19, 20, 21, and 22 respectively. In some cases, these stain-free all-in-focus imaging methods involve multi-spectral imaging. In various examples, stain-free all-in-focus imaging methods include an APIC technique. Examples of APIC techniques are described in Cao, R., Shen, C. & Yang, C., “High-resolution, large field-of-view label-free imaging via aberration-corrected, closed-form complex field reconstruction,” Nat Commun 15, 4713 (2024), which is incorporated by reference herein.

### Angular Ptychographic Imaging With Closed-Form (APIC)

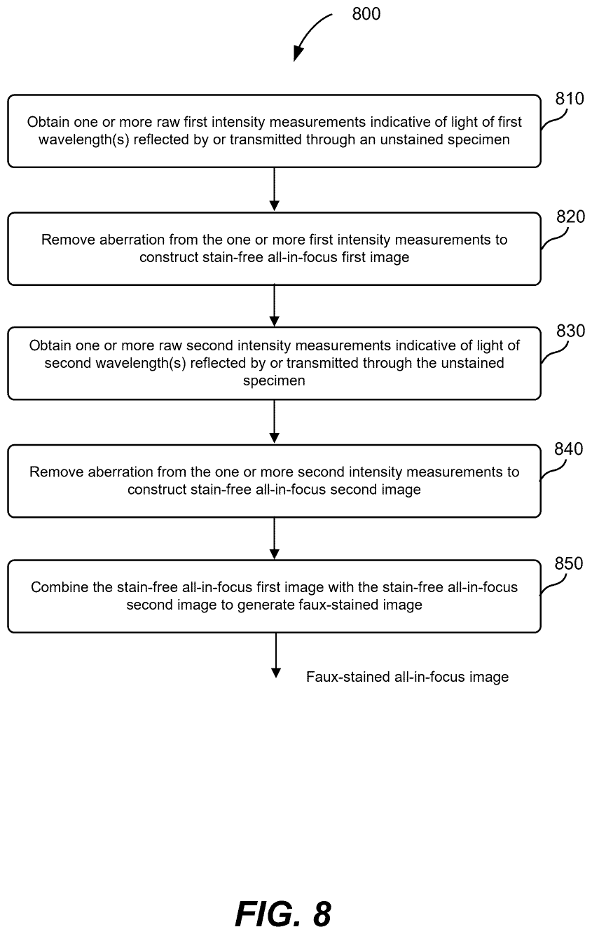

FIG. 7 depicts a schematic diagram depicting an example of some operations of an APIC technique, according to various embodiments. During image acquisition, each of a plurality of first light sources (e.g., visible light sources 215 in FIG. 2) for providing light of a first wavelength is activated sequentially to illuminate the unstained specimen through a series of oblique angles. These oblique illumination angles approximately match the maximum acceptance angle of the objective lens (e.g., objective 233 in FIG. 2). By changing the illuminating angle, various positions in the spatial frequency domain can be scanned by the coherent transfer function (CTF). A light detector measures an intensity image for every incident illumination angle, and the set of intensity measurements contains information on different regions of the sample's spectrum 710. The APIC technique reconstructs a complex field from these intensity measurements. Using the Kramers-Kronig (KK) relations, the APIC technique performs phase retrieval analytically from the individual intensity measurements' spectra 720. During reconstruction, the APIC technique extracts an estimated system aberration 730 using the phase differences of pairs of spectra with overlaps in their sampled spectrum. Then, the APIC technique corrects the reconstructed complex fields with estimated aberration and stitches the corrected reconstructed complex spectra together to generate a recovered spectrum 740. The recovered spectrum 740 can be inverse Fourier transformed into an aberration-free, high-resolution all-in-focus image (e.g., phase image, amplitude image, and/or complex image with both amplitude and phase information).

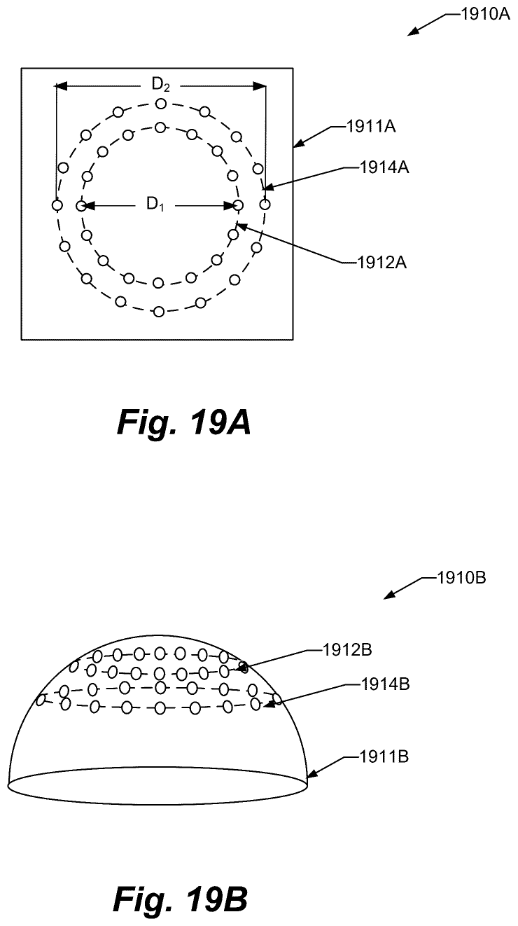

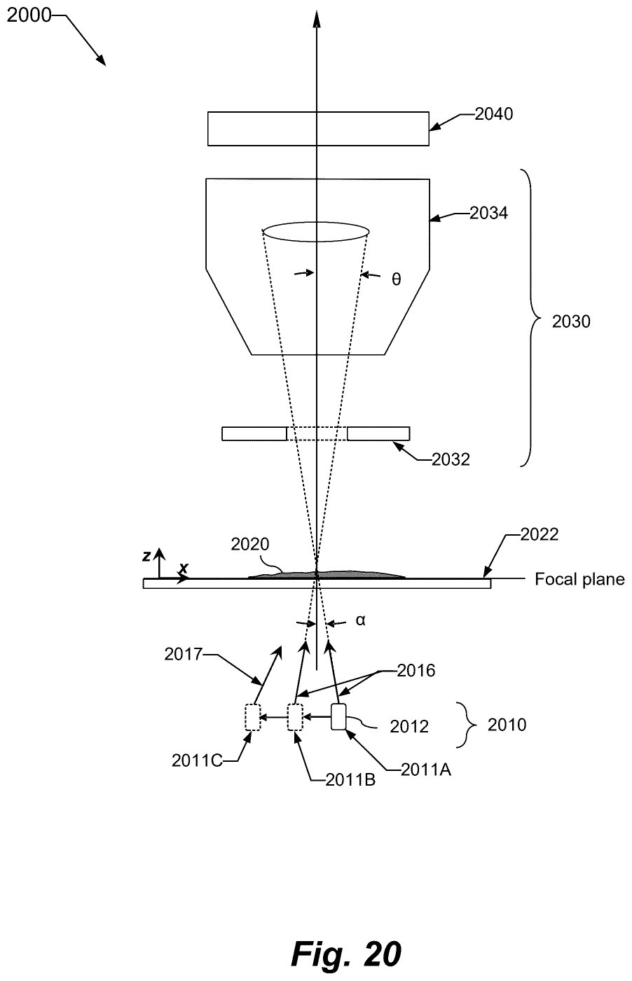

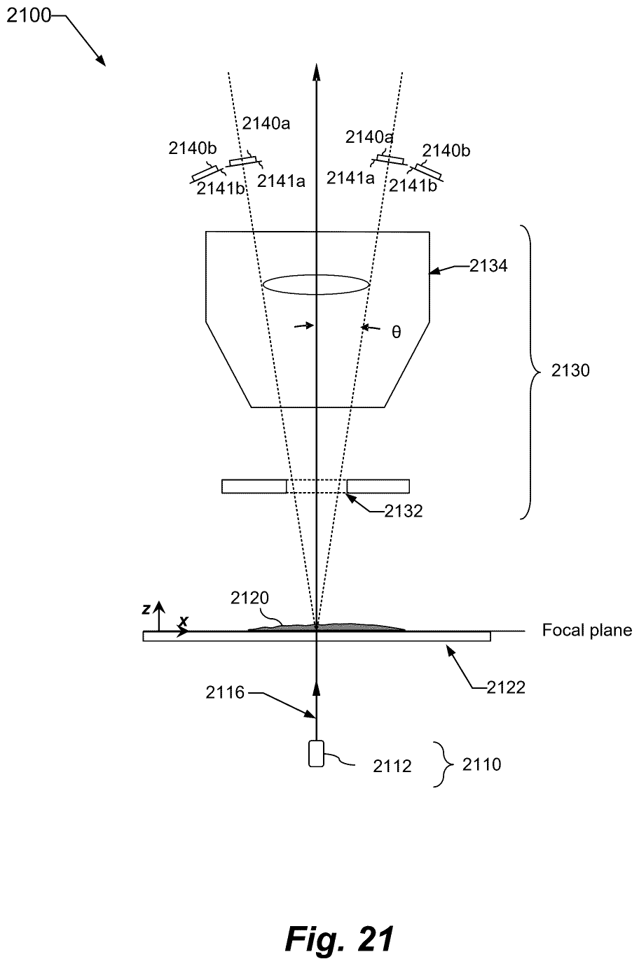

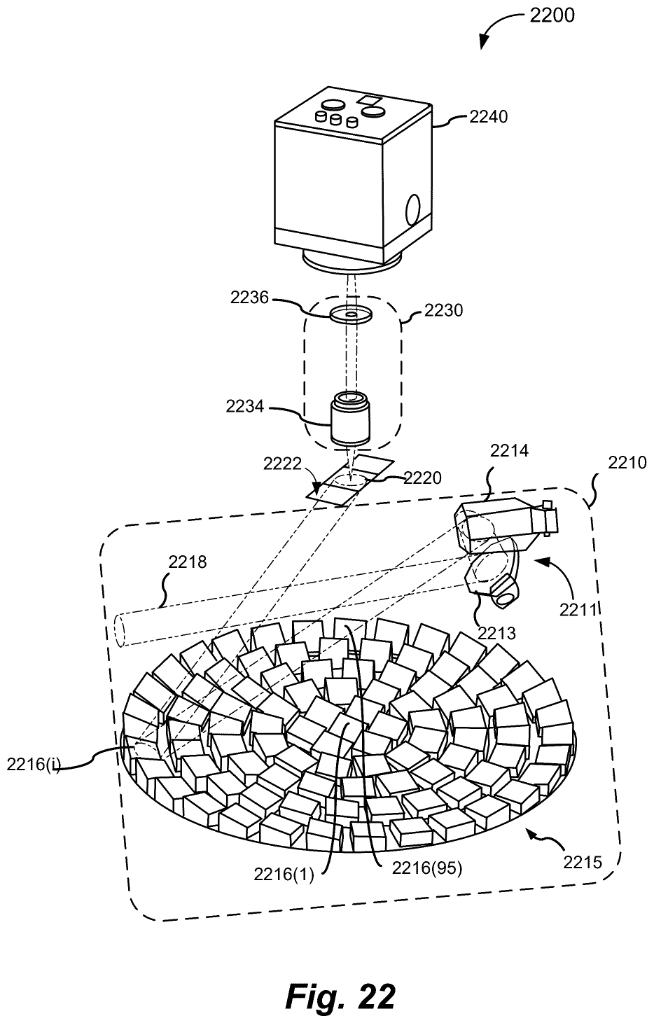

In various examples, an APIC technique includes a procedure for reconstructing complex field spectra corresponding to a plurality of intensity measurements acquired by an imaging system (e.g., UV-VIS-APIC system 200 in FIG. 2, system 1900 in FIG. 19, system 2000 in FIG. 20, system 2100 in FIG. 21, or system 2200 in FIG. 22) under oblique illuminations. A complex field spectrum may be reconstructed for each intensity measurement in an image-wise field reconstruction. For example, Kramers-Kronig relations may be employed to reconstruct the complex field spectra from a Fourier transform of the plurality of intensity measurements. An example of Kramers-Kronig relations can be found in Baek, Y. & Park, Y., “Intensity-based holographic imaging via space-domain Kramers-Kronig relations,” Nat. Photonics 15, 354-360 (2021), which is hereby incorporated by reference for the Kramers-Kronig relations.

In various implementations that employ an APIC technique, intensity measurements are taken during exposure time durations when illumination angles match the maximum acceptance angle of the collection optics (e.g., objective 232 in FIG. 2). Various numbers of intensity measurements may be used to reconstruct respective complex field spectra. For example, certain stain-free all-in-focus imaging methods use between 6-20 intensity measurements. In some examples, stain-free all-in-focus imaging methods use at least 6 intensity measurements, at least 7 intensity measurements, at least 8 intensity measurements, at least 9 intensity measurements, or at least ten (10) intensity measurements.

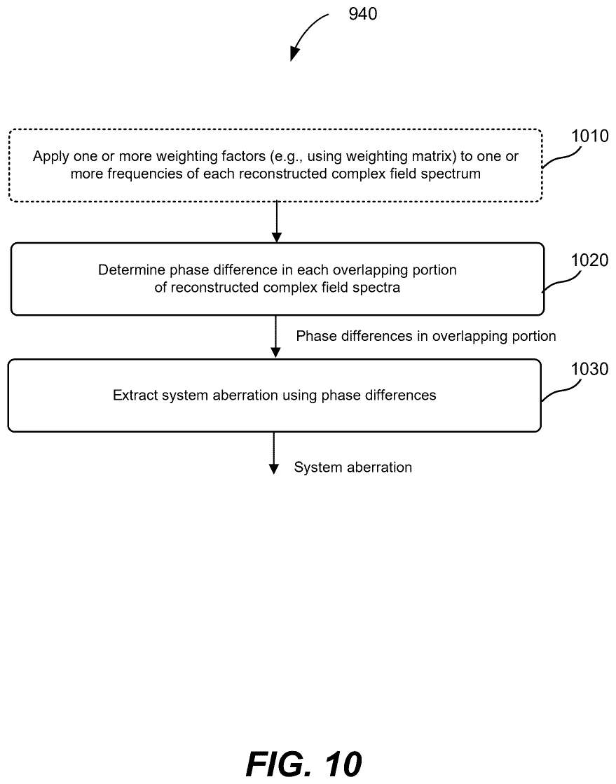

In various implementations, an APIC technique includes a process for extracting aberration introduced by system optics such as an objective (e.g., 232 in FIG. 2). In these implementations, the APIC technique determines a phase difference in each overlapping portion of the reconstructed complex field spectra and uses the phase differences to extract the aberration. The APIC technique may use the extracted aberration to correct the reconstructed complex field spectra and then stitch (sum) the corrected spectra together to obtain an aberration-free reconstructed sample spectrum. Once the aberration-free sample spectrum is reconstructed, an aberration-free sample image can be obtained via reverse Fourier transform. FIG. 10 shows an example of suboperations of operation 840 in FIG. 8 that provide operations for extracting an aberration.

### Examples of Stain-Free All-in-Focus Imaging Methods

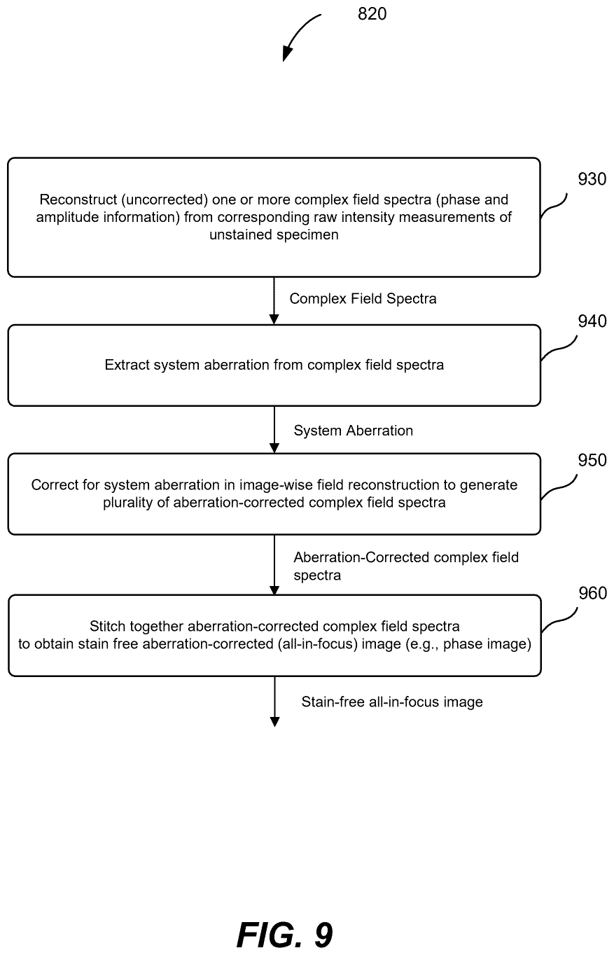

FIG. 8 is a flow diagram depicting an example of a stain-free all-in-focus imaging method 800 with multi-spectral imaging, according to various implementations. FIG. 9 is a flow diagram depicting an example of suboperations of operation 820 in FIG. 8 in which APIC reconstruction is implemented. FIG. 10 is a flow diagram depicting an example of suboperations of suboperation 940 in FIG. 9 in which APIC reconstruction is implemented to extract system aberration.

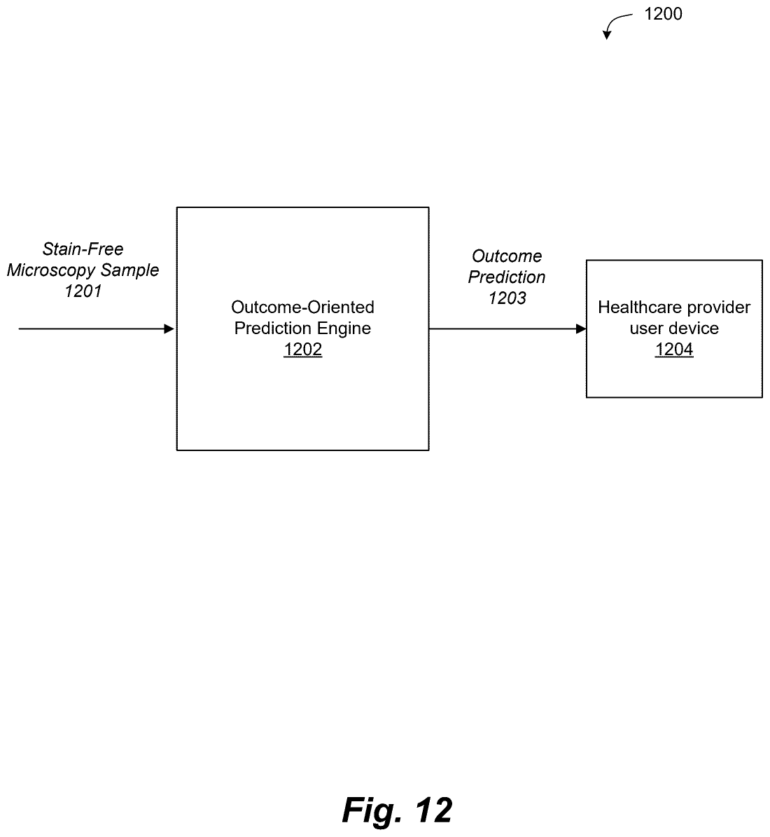

One or more of the functions of the stain-free all-in-focus imaging method 800 may be performed by a computing device (e.g., computing device 280 in FIG. 2 or computing device 1200 of FIG. 12). Means for performing the functionality illustrated in one or more of the operations shown in FIG. 8 and suboperations shown in FIGS. 9 and 10 may include hardware and/or software components of one or more computing devices, such as, for example, a controller apparatus, or a computer-readable apparatus including a storage medium storing computer-readable and/or computer-executable instructions that are configured to, when executed by at least one processor, cause the at least one processor or another apparatus to perform the functions.

It should also be noted that the operations of the stain-free all-in-focus imaging method 800 depicted in FIG. 8 and the suboperations depicted in FIGS. 9-10 may be performed in different orders and/or with different, fewer, or additional operations according to other implementations. For example, operation 830 may be performed before operation 820 or simultaneous to operation 810. As another example, in an alternative implementation that utilizes illumination of a single wavelength or single range of wavelengths (mono-spectral configuration), the stain-free all-in-focus imaging method 800 may omit operations 830, 840, and 850. In some implementations, one or more of the operations or suboperations may be implemented, at least in part, according to software stored in one or more non-transitory computer readable media.

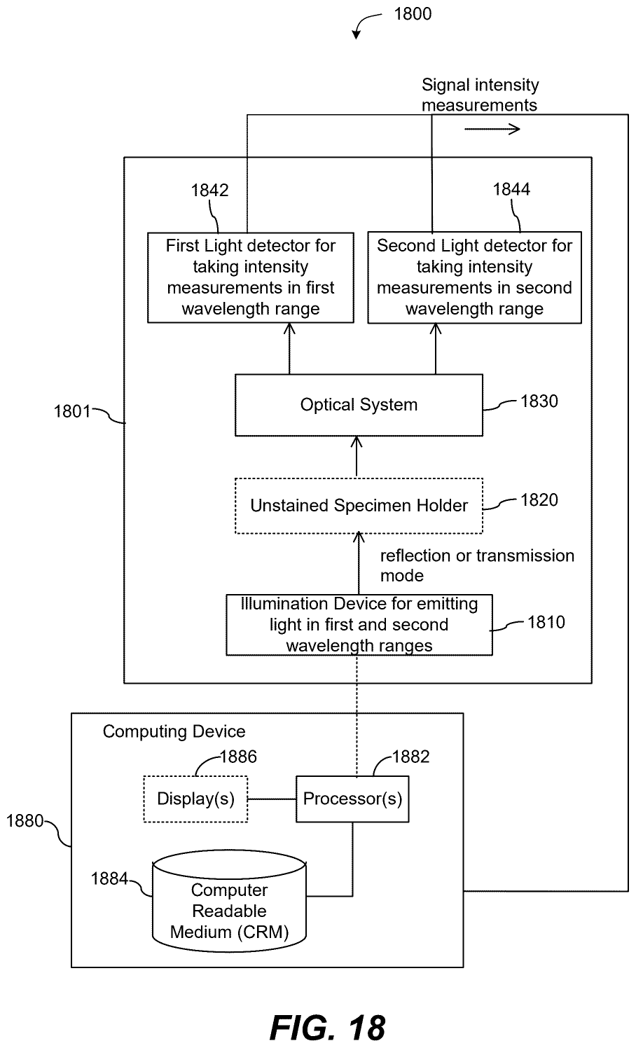

Turning to FIG. 8, at operation 810, one or more raw first intensity measurements of an unstained specimen is/are obtained. The first intensity measurement(s) may be retrieved from memory or received directly in a signal from a first light detector (e.g., visible light detector 240 in FIG. 2 or light detector 1842 in FIG. 18) during an imaging procedure. The first intensity measurement(s) are indicative of light of a first wavelength or a range of first wavelengths (e.g., visible light wavelength spectrum between 380 nm and 780 nm) reflected by, or transmitted through, the unstained specimen. The stain-free all-in-focus imaging method 800 may send control signals (e.g., using a computing device) to an illumination device configured to emit light of the first wavelength(s) and/or to the first light detector configured to capture intensity images of light of the first wavelength(s). The control signals cause the first light detector to capture the first intensity measurement(s) while illumination is provided by the illumination device. For example, as shown in FIG. 2, a sample holder 222 with an unstained specimen 220 may be positioned within the UV-Vis-APIC system 200 during an imaging procedure in the transmission mode. During the imaging procedure, the stain-free all-in-focus imaging method 800 may cause the illumination device 210 to activate the visible light sources 215 in sequence to emit visible light to illuminate the unstained specimen 220 at a plurality of oblique illumination angles and/or cause the visible light detector 240 to capture the one or more intensity measurements. In one case, the illumination angles may match (be approximately equal to) the acceptance angle of the objective 233. In an alternative implementation, multiplexing illumination may be employed where the unstained specimen is illuminated by a sequence of illumination patterns where each illumination pattern includes simultaneous illumination from multiple illumination angles of the plurality of illumination angles.

At operation 820, aberration is removed from the one or more first intensity measurements to produce a stain-free all-in-focus first image. In various implementations, an APIC technique is used to reconstruct complex field spectra (phase and amplitude information) from the first intensity measurements during which the aberration is extracted and can be corrected and the corrected spectra stitched together in the Fourier domain to obtain a stain-free all-in-focus image such as an all-in-focus phase image.

FIG. 9 is a flow diagram depicting an example of suboperations of operation 820 in FIG. 8 in which APIC reconstruction is implemented where a plurality of first intensity measurements corresponding to respective plurality of illumination angles being used.

At suboperation 930, a complex field spectrum (with phase and amplitude information) is reconstructed from a Fourier transform of each of the intensity measurements to generate a plurality of complex field spectra. Kramers-Kronig relations may be used to reconstruct the complex field spectra from the Fourier-transformed intensity measurements. The complex field spectrum may be restored in real space with inverse Fourier transform and by applying an exponential function to each point of the inverse transform.

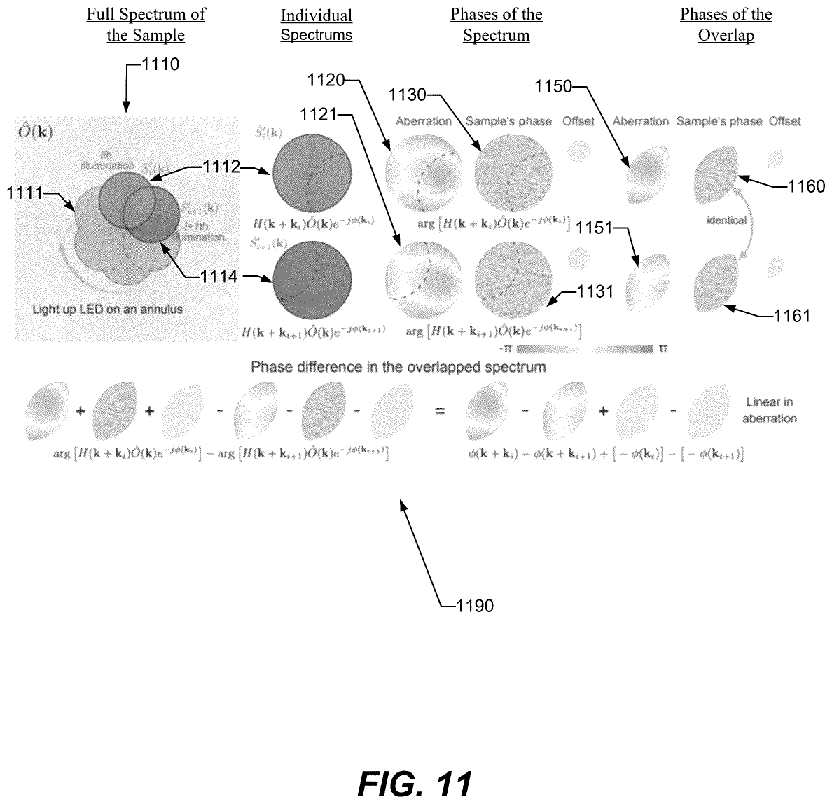

At suboperation 940, a system aberration is extracted from the plurality of reconstructed complex field spectra. FIG. 11 provides an illustration of suboperations of suboperation 940. As shown in and described with reference to FIG. 11, at an overlapping portion of two reconstructed spectra, the phase difference due to the sample spectrum cancels out and the phase difference depends (linearly) on the system aberration. The system aberration is determined by multiplying the signal by a linear operator. The linear operator maps the phase differences of the overlapping portions of the complex field spectra to the system aberration.

FIG. 10 depicts example suboperations of suboperation 940, according to some embodiments. At optional (denoted by dashed line) suboperation 1010, one or more weighting factors may be applied to one or more spatial frequencies in each reconstructed complex field spectrum reconstructed from a corresponding intensity measurement. In one aspect, the one or more weightings factors place a greater weight on spatial frequencies with a stronger signal than other spatial frequencies in the spectrum. It may be advantageous to apply greater weight to these spatial frequencies with stronger signals since these signals generally have higher signal-to-noise ratio (SNR) and emphasizing these frequencies may provide a better result. In one aspect, a weighting matrix is applied to emphasize one or more frequencies in the spectrum with higher SNR.

As discussed in more detail with reference to FIG. 11, at an overlapping portion of two reconstructed spectrums, the phase difference due to the sample spectrum cancels out and the phase difference solely depends on the system aberration. As shown by the illustration 1190 in FIG. 11, the phase difference in the overlapping portion is a linear combination of the system aberration. Due to this, a linear operator may be determined that accounts for the phase differences. The linear operation may then be used to recover the system aberration from the phase differences in the overlapping portions.

Returning to FIG. 10, at suboperation 1020, the phase difference in each overlapping portion of the reconstructed spectra is determined by subtracting the phase of the overlapping reconstructed spectra. For example, as illustrated in FIG. 11, the phase of the first reconstructed spectrum 1112 of the overlap (consists of 1150, 1160 and an offset) may be subtracted from the phase of the overlapping part of second reconstructed spectrum 1114 (consists of 1151, 1161 and another offset) to determine the phase difference.

At suboperation 1030, a system aberration may be determined using the phase differences from the overlapping portions. In certain implementations, the system aberration is determined by solving for the linear operator that maps the phase differences of the overlapping portions of the complex field spectra to the system aberration. In one implementation, the phase differences of a smaller set of pairs of overlapping spectra from the total number of pairs of overlapping spectra in the full spectrum of the sample are used, which may be advantageous to reduce computational resources.

Returning to FIG. 9, at operation 950, the aberration is corrected in each of the complex field spectra to generate a plurality of aberration-corrected complex field spectra. To remove the system aberration from each reconstructed spectrum, the conjugate of the system aberration is subtracted from the reconstructed spectrum to generate a corresponding aberration-corrected spectrum.

At operation 960, the aberration-corrected spectra are stitched together to generate a reconstructed sample spectrum, and applying an inverse Fourier transform to the reconstructed sample spectrum generates the aberration-free complex field of the stain-free specimen. For example, the aberration-corrected spectra may be “stitched together” with weighted averaging knowing their corresponding illumination angle. The phase or absorption information can then be extracted from the reconstructed complex field to produce stain-free, all-in-focus images.

Returning to FIG. 8, at operation 830, one or more raw second intensity measurements of the unstained specimen is/are obtained. The second intensity measurement(s) may be retrieved from memory or received directly in a signal from a second light detector (e.g., ultraviolet light detector 270 in FIG. 2 or second light detector 1844 in FIG. 18) during an imaging procedure. The second intensity measurement(s) are indicative of light of a second wavelength or a range of second wavelengths (e.g., deep ultraviolet spectrum between 100 nm and 280) reflected by, or transmitted through, the unstained specimen. The stain-free all-in-focus imaging method 800 may send control signals to the illumination device configured to emit light of the second wavelength(s) and/or to a second light detector configured to capture intensity images of light of the second wavelength(s). The control signals cause the second light detector to capture the second intensity measurement(s) while illumination is provided by the illumination device. For example, as shown in FIG. 2, a sample holder 222 with an unstained specimen 220 may be positioned within the UV-Vis-APIC system 200 during an imaging procedure in the transmission mode. During the imaging procedure, the stain-free all-in-focus imaging method 800 may cause the illumination device 210 to activate the ultraviolet light source 216 to emit ultraviolet light at the same time the illumination device 210 activates at least one of the visible light sources 215 and/or cause the ultraviolet light detector 270 to capture the one or more intensity measurements. For instance, FIG. 2 illustrates an instant during an exposure duration of the imaging procedure in which first visible light source 215a and ultraviolet light source 216 are illuminated and the ultraviolet light detector 270 captures a UV absorption image and the visible light detector 240 captures an intensity image associated with illumination at an illumination angle associated with the first visible light source 215a.

While imaging the unstained specimen, defocusing is a common source that compromises data quality. Defocus can be caused by the specimen's unevenness in height or the misplacement of the sample. In one implementation (at operation 840), the APIC technique may be used to estimate the defocus distance and correct it after data acquisition, thus leading to an all-in-focus reconstructed image. In a different implementation, an axial scanning method can be implemented to obtain in-focus raw intensity measurements. The focus quality can be estimated with metrics such as an absolute central momentum, Laplacian operator, Tenegrad, etc. With an exponential/binary search method, the focal plane can be determined efficiently.

At operation 850, the stain-free all-in-focus first image (e.g. intensity image with DUV) is combined with the stain-free all-in-focus second image (e.g. phase image with a visible wavelength) to generate a faux-stained all-in-focus image through linear image coupling and mapping.

FIG. 11 is a diagram depicting an original spectrum 1111 of a sample, Ô(k), and a phase difference between two individual spectrums 1112, 1114 with overlap, according to an implementation. The original spectrum 1111 includes six individual spectra corresponding to a plurality of six (6) NA-matching illumination angles. For aberration extraction, one or more illumination sources (e.g., LEDs) are used whose illumination k vector matches with the maximal receiving angle of the imaging system kᵢ=NA. In the illustrated example, the illumination sources are LEDs. For illustration purposes, l=i+1 is selected as the LEDs are lit up along an annulus. The original spectrum 1111 includes a plurality of six overlapping spectra including a first reconstructed spectrum 1112 and a second reconstructed spectrum 1114 with overlap. Ô(k) stands for the original sample's spectrum, Ŝᵢ(k) is the acquired spectrum under i^{th} illumination, and H(k) is the coherent transfer function (CTF). Illustration 1120 depicts the aberration of first constructed spectrum 1112 and illustration 1121 depicts the aberration of second constructed spectrum 1114. Illustration 1130 depicts the sample's phase of first constructed spectrum 1112 and illustration 1131 depicts the sample's phase of second constructed spectrum 1114. Illustration 1150 depicts the aberration of first constructed spectrum 1112 at the overlap between the first constructed spectrum 1112 and second constructed spectrum 1114. Illustration 1151 depicts the aberration of second constructed spectrum 1114 at the overlap between the first constructed spectrum 1112 and second constructed spectrum 1114. Illustration 1160 depicts the sample's phase of first constructed spectrum 1112 at the overlap between the first constructed spectrum 1112 and second constructed spectrum 1114. Illustration 1161 depicts the sample's phase of second constructed spectrum 1114 at the overlap between the first constructed spectrum 1112 and second constructed spectrum 1114. As shown, in the overlapping region between individual spectra 1112 and 1114, the phase of the sample cancels out and the phase difference of the shifted CTF solely contributes to the measured phase difference. As shown in the illustration 1190, the phase difference in the overlapping portion is a linear combination of the system aberration. The phase difference is linearly dependent on the system aberration. Thus, an operator can be determined that accounts for the shift induced phase difference and this operator can be used to recover the imaging system's aberration.

### III. Machine Learning Models

FIG. 12 illustrates an example system 1200 that utilizes deep learning for outcome predictions in accordance with some embodiments. As illustrated, the system 1200 includes an outcome-oriented prediction engine 1202. In some implementations, the outcome-oriented prediction engine 1202 may include a trained machine learning model configured to take, as input, a stain-free microscopy sample 1201, and generate, as an output, an outcome prediction 1203. The trained machine learning model may be a deep neural network (DNN), residue neural network, vision transformers, or any other suitable architecture for deep learning. These neural network architectures can potentially process gigapixel images from different levels. In some cases, the stain-free microscopy sample 1201 may be represented as a digital image such as a faux-stained image. In certain instances, the faux-stained image may be digitally focused. Examples of faux-stained all-in-focus images may be computationally generated by stain-free all-in-focus imaging techniques described herein such as the UV-Vis-APIC system 200 shown in FIG. 2 or the systems 1700, 1800, 1900, 2000, and 2100, shown in FIGS. 17, 18, 19, 20, and 21 respectively. In other cases, the stain-free microscopy sample 1201 is a stain-free specimen on a slide or other receptable. The stain-free specimen may be generated from a tissue biopsy (e.g., tumor biopsy) or another tissue sample. In some cases, the microscopy sample may be a fixed tissue section on the slide or other receptable. In other cases, the microscopy sample may not be fixed which can avoid fixation-related variability from the images. For example, the microscopy sample may be a fresh tissue section or may be liquid-based sample such as a tissue sample in liquid (e.g., blood, urine, saliva, etc.) placed on a microscope slide or other receptacle. In these cases, the outcome-oriented prediction engine 1202 may also perform operations of a stain-free all-in-focus imaging technique to produce a faux-stained image from the stain-free specimen according to certain embodiments. For example, the outcome-oriented prediction engine 1202 may take, as input, an unstained microscopy sample and produce a faux-stained image using, for example, the method 800 shown in FIG. 8.

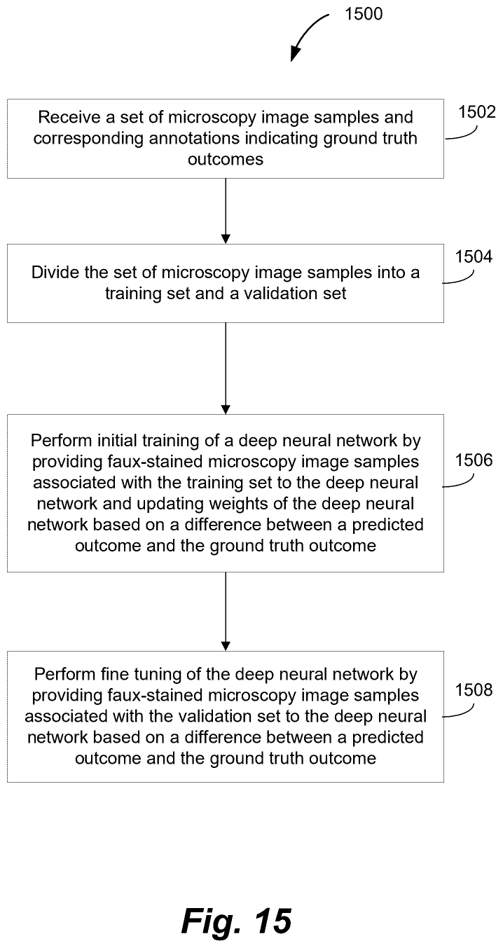

In certain instances, the outcome-oriented prediction engine 1202 includes a trained machine learning model such as a trained deep neural network (DNN) or other similar architecture. The trained machine learning model may be utilized at inference time on a server device, a laptop computer, a desktop computer, or any other suitable computing device. Note that, in some embodiments, the machine learning model may be trained on a device (e.g., a server device, a laptop computer, a desktop computer, etc.) that is different from the computing device on which the machine learning model operates at inference time. Example techniques for training a machine learning model are shown in and described below in connection with FIG. 15. Example components of computing devices which may be used to utilize a trained machine learning model at inference time, or to train a machine learning model, are computing devices 280, 1780 and 2450 shown in and described below in connection with FIGS. 2, 17, and 24 respectively.

In certain implementations, the outcome-oriented prediction engine 1202 takes, as input or computationally produces, a stain-free microscopy image representing the microscopy sample, and then generates, as output, an outcome prediction 1203. For example, the stain-free microscopy image used as input may be a faux-stained all-in-focus image produced by a stain-free all-in-focus imaging method such as method 800 in FIG. 8. In some cases, the outcome prediction 1203 may correspond to a likelihood of a progression of a disease state of a patient associated with the microscopy sample. For example, the outcome prediction 1203 may correspond to a likelihood of metastasis (e.g., brain metastasis, or the like), a likelihood of death, or any other suitable outcome prediction. Note that in some instances the outcome prediction 1203 may be associated with a time window. For example, the outcome prediction 1203 may represent the likelihood of an event occurring within the time window (e.g., the next five years, the next ten years, etc.). The outcome prediction may be a binary value (e.g., “a high likelihood” versus a “a low likelihood”), or may be a continuous value (e.g., a continuous number from 0 to 1, from −1 to 1, etc.).

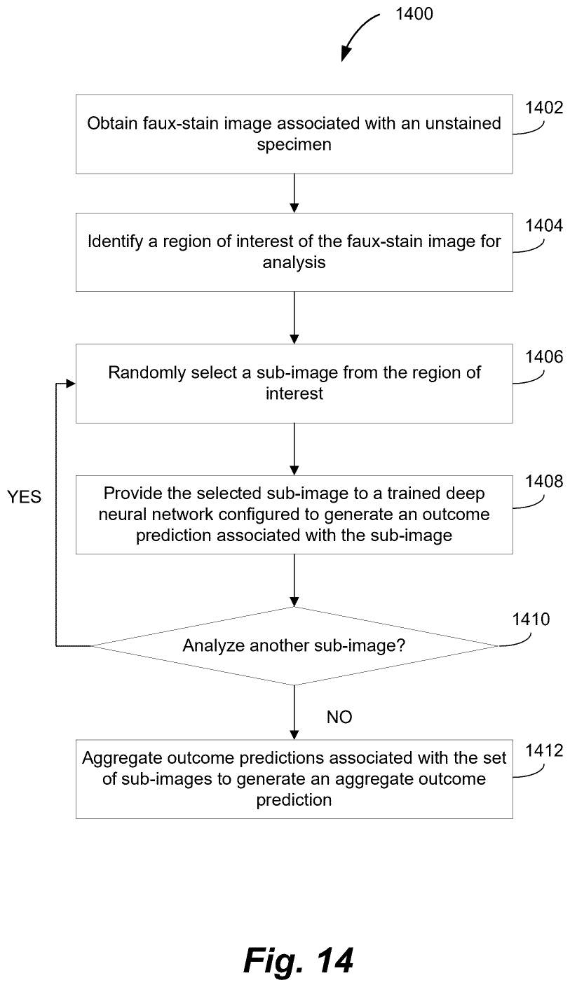

In some embodiments, the machine learning model included in outcome-oriented prediction engine 1202 may analyze or consider sub-regions of a microscopy sample image. For example, each sub-region may be randomly selected. As a more particular example, each sub-region may be randomly selected from a region corresponding to a tumor region. In some embodiments, the machine learning model may assign an outcome prediction to each sub-region. The outcome-oriented prediction engine 1202 may then aggregate the outcome predictions associated with each sub-region. Example techniques for utilizing a machine learning model to make outcome predictions are shown in and described below in connection with FIG. 14.

In some embodiments such as the illustrated example shown in FIG. 12, the outcome prediction 1203 is provided to a healthcare user device 1204. Healthcare user device 1204 may be a mobile phone, a laptop computer, a tablet computer, a desktop computer, a server device, a cloud service device, etc. For example, in some embodiments, healthcare user device 1204 may be a mobile device of a physician, such as an oncologist. The physician may then be able to use the outcome prediction 1203 to tailor treatment to the patient based on the prediction. As another example, in some embodiments, healthcare user device 1204 may be a server or other remote device, e.g., associated with an electronic healthcare records system or the like. In some embodiments, a physician may be able to access the server or remote device, e.g., via a desktop computer, laptop computer, or the like to access the outcome prediction and thereby determine suitable treatment options based on the outcome prediction.

In some embodiments, a trained machine learning model of the outcome-oriented prediction engine 1202 may be used to generate outcome predictions associated with an unstained specimen. For example, the machine learning model may receive a stain-free microscopy image, or may receive a sub-image of the unstained specimen. The image, or the sub-image, a may then be provided to the machine learning model as an input. The machine learning model may generate an output that corresponds to an outcome prediction. For example, the outcome prediction may be a prediction of whether or not a particular disease progression (e.g., metastasis of a tumor, death, etc.) will occur within a future time window (e.g., within the next year, within the next five years, within the next ten years, etc.). In some embodiments, the machine learning model may additionally generate a confidence associated with the outcome prediction. In some embodiments, the outcome prediction may be a continuous value (e.g., between −1 and 1, between 0 and 1, etc.) representing a probability of a particular outcome occurring (e.g., that metastasis will occur, or the like). In some embodiments, the outcome prediction may be a binary value corresponding to “yes” the outcome is likely, or “no” the outcome is not likely. In instances in which a binary value is generated, the binary value may be generated by comparing a probability to a threshold and determining the binary value based on the comparison of a probability of the outcome occurring to the threshold.

In some embodiments, a machine learning model may consider multiple sub-images of the stain-free microscopy sample image. For example, the machine learning model may consider ten, fifty, one hundred, one thousand, ten thousand, etc. sub-images. In some embodiments, the machine learning model may generate an outcome prediction and/or a confidence level for each sub-region. The outcome predictions associated with each sub-region analyzed may then be aggregated to generate an aggregate outcome prediction. For example, in an instance in which the outcome prediction is a continuous value (e.g., from −1 to 1, 0 to 1, or the like), the median outcome prediction may be determined from the outcome predictions of all of the sub-regions to determine the aggregate outcome prediction. In some embodiments, each sub-region may be equally weighted to determine the aggregate outcome prediction. Alternatively, in some embodiments, different sub-regions (e.g., those near a center of a tumor region, those near an edge of a tumor region, etc.) may be weighted more or less heavily than other sub-regions.

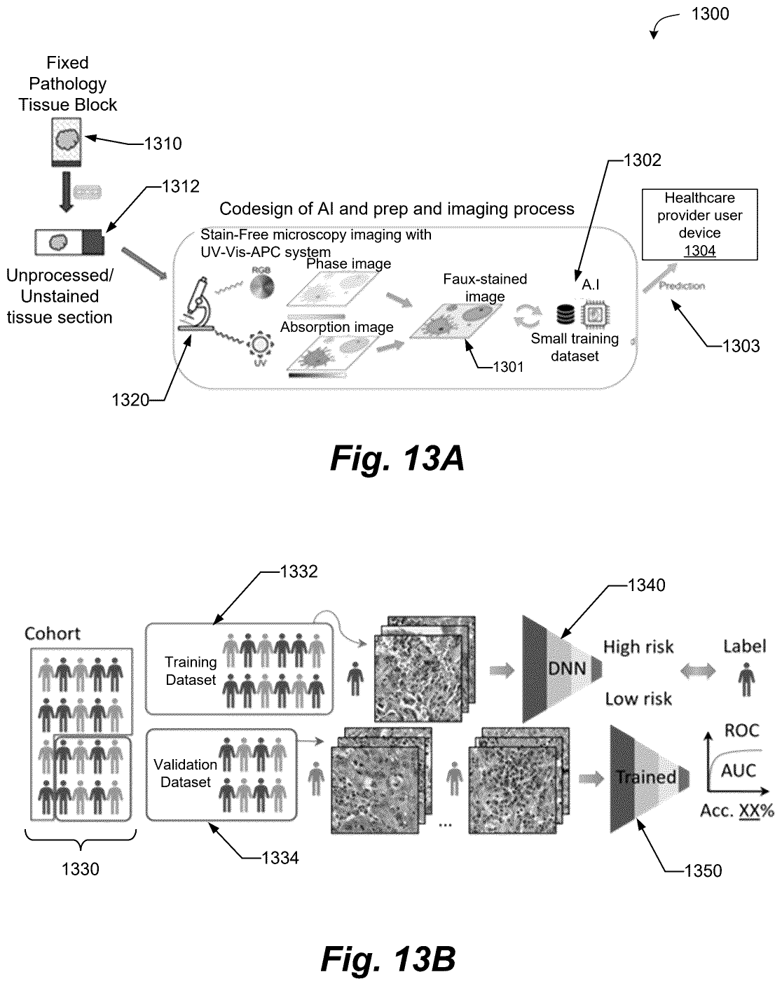

FIG. 13A is a schematic diagram of components of a system 1300 that includes a UV-Vis-APIC system 1320 for generating faux-stained images and an outcome-oriented prediction engine 1302 that uses deep learning for outcome predictions (sometimes referred to herein as a “co-design of AI and prep-and-imaging technique”), in accordance with some embodiments. The outcome-oriented prediction engine 1302 includes a machine learning model such as a DNN or other similar architecture. In one implementation, the UV-Vis-APIC system 1320 has components similar to those shown in and described with reference to UV-Vis-APIC system 200 in FIG. 2. In one implementation, the outcome-oriented prediction engine 1302 may be similar to the outcome-oriented prediction engine 1202 described with reference to FIG. 12.

As illustrated, the UV-Vis-APIC system 1320 receives, as input, an unprocessed/unstained tissue section sample 1312 taken from a fixed pathology tissue block 1310. The UV-Vis-APIC system 1320 uses an APIC technique to generate an all-in-focus phase image using a plurality of intensity measurements captured while the unprocessed/unstained tissue section sample 1312 is illuminated by visible light under a sequence of oblique illumination angles. The UV-Vis-APIC system 1320 also generates an all-in-focus UV absorption image indicative of UV light absorbed by unprocessed/unstained tissue section sample 1312. The UV-Vis-APIC system 1320 combines the visible light phase image with the UV absorption image to produce a faux-stained image 1301 which is used as input into the outcome-oriented prediction engine 1302. The trained machine learning model can take, as input, the faux-stained image 1301, and generate, as an output an outcome prediction 1303. The outcome prediction 1303 may be provided to a healthcare user device 1304 which can be operated by a healthcare user such as an oncologist. Since the faux-stained images avoid the variability from chemical staining, the machine learning model can be trained on a training set of faux-stained microscopy images of unstained specimens that is smaller and yields higher accuracy than a training set of microscopy images of chemically-stained specimens.

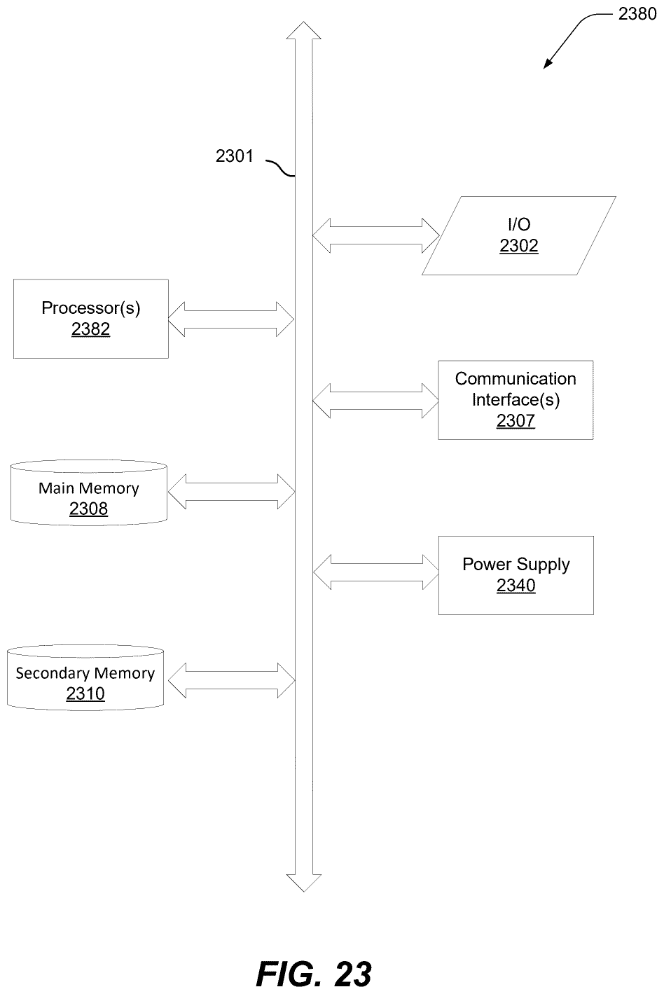

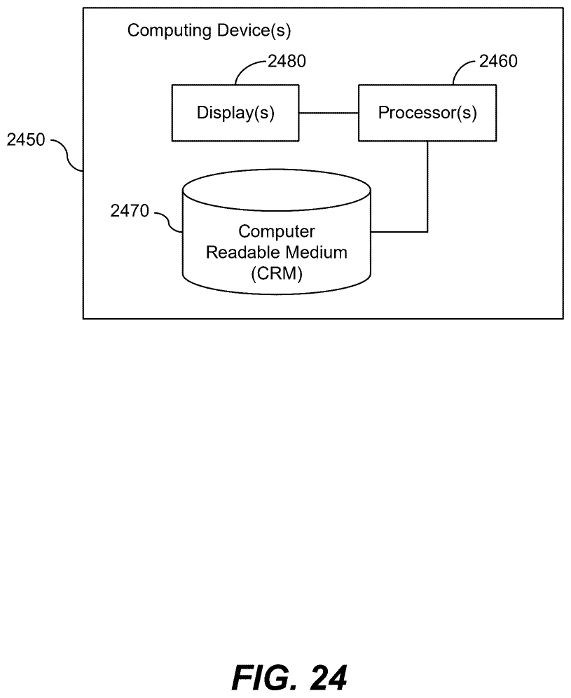

FIG. 14 is a flowchart of an example process 1400 for generating outcome predictions using a DNN in accordance with some embodiments. Note that blocks of process 1400 may be performed using a trained DNN. Example techniques for training such a DNN are shown in and described below in connection with FIG. 15. In some embodiments, blocks of process 1400 may be executed by a computing device, such as a server device, a laptop computer, a desktop computer, or the like. Example components of such a computing device are shown in and described below in connection with FIG. 2, FIG. 18, FIG. 23, and FIG. 24. In one example, blocks of process 1400 are executed by computing device 280 and other system components of UV-Vis-APIC system 200 in FIG. 2. In another example, blocks of process 1400 are executed by computing device 1780 and other system components of system 1800 in FIG. 18. In other examples, blocks of process 1400 are executed by components of system 1800 in FIG. 18, system 1900 in FIG. 19, system 2000 in FIG. 20, or system 2100 in FIG. 21. In some embodiments, blocks of process 1400 may be executed in an order other than what is shown in FIG. 14. In some embodiments, two or more blocks of process 1400 may be executed substantially in parallel. In some embodiments, one or more blocks of process 1400 may be omitted.

Process 1400 can begin at 1402 by obtaining a faux-stained microscopy image associated with an unstained specimen. The unstained specimen may be, e.g., a biopsy of a tumor or other tissue. The unstained specimen may be fixed to form a whole slide. In one embodiment, block 1402 includes the operations of method 800 shown and described with reference to FIG. 8. In one example, the first wavelengths of illumination are in the visible light spectrum between 380 nm and 700 nm and the second wavelengths of illumination are in the deep ultraviolet spectrum between 200 and 280 nm. In one case, the second wavelength is 265 nm. In an alternative embodiment, at 1402, the process 1440 obtains an unstained specimen and uses a computational technique such as operations of method 800 in FIG. 8 to produce the faux-stained microscopy image.

At 1404, process 1400 can identify a region of interest of the faux-stained microscopy image for analysis. In some embodiments, the region of interest may correspond to a region or a boundary of a particular type of tissue, such as a tumor. In some embodiments, the region of interest may be identified based on manual annotation of the faux-stained microscopy image. For example, a tumor region may be identified by a pathologist. As another example, in some embodiments, the region of interest may be identified by a trained neural network (e.g., a convolutional neural network) trained to identify boundaries of particular content, such as a tumor region. In some embodiments, process 1400 can generate a mask based on the region of interest. For example, in some embodiments, process 1400 can perform thresholding to generate a mask with binary pixel values, with pixel values corresponding to either within the region of interest or not within the region of interest.

At 1406, process 1400 can randomly select a sub-image from the region of interest. For example, in some embodiments, process 1400 can select a set of pixels that correspond to the sub-image, where the set of pixels are within the region of interest. In some embodiments, the sub-image may be selected with uniform probability from within the region of interest. Alternatively, in some embodiments, the sub-image may be selected with non-uniform probability from within the region of interest, such that regions near an edge of the region of interest, or regions within a center of the region of interest are more likely to be selected.

At 1408, process 1400 can provide the selected sub-image to a trained DNN configured to generate an outcome prediction associated with the sub-image. As described above, the outcome prediction may indicate a likelihood of progression of a disease state of a patient associated with a test specimen or test sample. For example, in an instance in which the faux-stained microscopy image depicts a portion of a tumor in a first body region (e.g., the lung of the patient), the outcome prediction may indicate metastasis to a second body region (e.g., the brain). The outcome prediction may be a continuous value (e.g., between 0 and 1, between −1 and 1, or the like). Alternatively, the outcome prediction may be a binary value. In some embodiments, the outcome prediction may be associated with a confidence level, where lower levels of confidence indicate less accuracy or confidence in the outcome prediction.

It should be noted that the input layer of the DNN may be configured based on the type of faux-stained microscopy image that is obtained. For example, the DNN input layer may be configured to accept a single channel of phase information or two channels with amplitude and phase information. As another example, the DNN input layer may be configured to accept one channel or two channels of information, which may include absorption information in an amplitude channel.

At 1410, process 1400 can determine whether another sub-image is to be analyzed. In some embodiments, process 1400 may analyze a predetermined number of sub-images (e.g., ten, fifty, one hundred, one thousand, ten thousand, etc.) from within the region of interest. In some embodiments, process 1400 may determine another sub-image is to be analyzed responsive to determining that the number of sub-images that have thus far been analyzed is less than the predetermined number. In some embodiments, process 1400 may determine whether another sub-image is to be analyzed based on a variance in the outcome predictions for sub-regions that have been thus far analyzed. For example, in an instance in which the outcome predictions have high variance (e.g., a variance that is greater than a predetermined threshold), indicating high variability across the different sub-regions, process 1400 may determine that additional sub-images are to be analyzed. Conversely, in an instance in which the outcome predictions have low variance indicating low variability in the outcome predictions associated with sub-images across the region of interest, process 1400 may determine that no additional sub-images are needed.

If, at 1410, process 1400 determines that additional sub-images are to be analyzed (“yes” at 1410), process 1400 can loop back to 1406 and can randomly select another sub-image from the region of interest. Process 1400 can loop through blocks 1406-1410 until process 1400 determines that no additional sub-images are to be analyzed.

Conversely, if, at 1410, process 1400 determines that no additional sub-images are to be analyzed (“no” at 1410), process 1400 can proceed to block 1412 and can aggregate outcome predictions associated with the set of sub-images to generate an aggregate outcome prediction. For example, in some embodiments, the aggregate outcome prediction can be a median of the outcome predictions associated with the set of sub-images, a mean of the outcome predictions associated with the set of sub-images, a weighted average of outcome predictions associated with the set of sub-images, or the like. In some embodiments, one or more outlier outcome predictions may be discarded prior to determining the aggregate outcome prediction. For example, outlier outcome predictions may be identified using a clustering technique (e.g., to identify outcome predictions outside one or more clusters), based on outcome prediction values that are more than a threshold number of standard deviations away from a mean outcome prediction, or the like.

The aggregate outcome prediction may be a continuous value that represents a probability of disease progression, e.g., a value from −1 to 1 or from 0 to 1. In some embodiments, the aggregate outcome prediction may be transformed to a binary value. For example, a probability of disease progression may be compared to a threshold (e.g., a probability of 0.5, a probability of 0.6, etc.), and aggregate outcome predictions that exceed the threshold may be classified as “likely progression,” and aggregate outcome predictions below the threshold may be classified as “unlikely to progress.” Note that, in some embodiments, the threshold may be determined as part of the training of the DNN, e.g., during a validation phase of the DNN. For example, the threshold may be selected during the validation phase to achieve particular sensitivity and/or selectivity metrics with a training set and a validation set.

In some embodiments, a DNN may be trained using a training set and a validation set. In some embodiments, the training set may be used during an initial training phase to determine weights associated with the DNN. In some embodiments, after the initial training phase, the validation set may be used to tune hyperparameters of the DNN. The hyperparameters may include learning rate, batch size, weight decay, number of epochs, and/or learning scheduler. In some embodiments, a group of manually annotated faux-stained microscopy images may form a combined training set and validation set. Each faux-stained microscopy image may be manually annotated for regions of interest associated with a ground truth outcome. For example, in the case of faux-stained microscopy images that correspond to tumor biopsy images, the ground truth outcome may indicate a disease progression outcome, such as whether metastasis to a different body region occurred. For example, for a given faux-stained microscopy image, a corresponding label may be Met+ (indicating that metastasis occurred), or Met− (indicating metastasis did not occur). Note that other outcomes may be used rather than metastasis, such as death of the patient, a cancer progressing from early stage to invasive, etc. The training set and the validation set may be constructed such that each of the training set and the validation set include a balance of samples associated with each ground truth outcome. For example, the training set may include 20 Met+ and 20 Met− training samples, 30 Met+ and 50 Met− training samples, or any other suitable number. Similarly, the validation set may include a mix of samples associated with each ground truth outcome.

Each training sample (during the initial training phase) or each validation sample (during the fine-tuning stage) may be provided to the DNN in multiple instances. For example, a faux-stained microscopy image may be randomly sampled a number of times to generate a corresponding number of sub-regions that are each provided to the DNN. As described above in connection with FIG. 14, an outcome prediction may be generated for each sub-region. The outcome predictions for each sub-region may be aggregated (e.g., using a mean, a median, a weighted average, etc.) to determine an aggregate outcome prediction. The aggregate outcome prediction, which may be a continuous value (e.g., between −1 and 1, between 0 and 1, etc.) representing probability of a given outcome may be compared to a threshold to determine a binary aggregate outcome prediction. During the initial training phase, weights of the DNN may be updated based on a comparison of the binary aggregate outcome prediction to the ground truth outcome prediction. During the validation phase, hyperparameters may be tuned or modified based on a comparison of the binary aggregate outcome to the ground truth outcome. Note that, prior to providing a sub-region image to the DNN (whether in the initial training phase or the validation phase), suitable pre-processing may be performed. The DNN is trained using the same type of faux-stained images as is used by the DNN at inference time.

FIG. 15 is a flowchart of an example process 1500 for training a DNN in accordance with some embodiments. In some embodiments, blocks of process 1500 may be executed by a computing device, such as a server device, a laptop computer, a desktop computer, or the like. Example components of such a computing device are shown in and described below in connection with FIG. 8. In some embodiments, blocks of process 1500 may be executed in an order other than what is shown in FIG. 15. In some embodiments, two or more blocks of process 1500 may be executed substantially in parallel. In some embodiments, one or more blocks of process 1500 may be omitted.

Process 1500 can begin at 1502 by receiving a set of faux-stained microscopy image samples and corresponding annotations indicating ground truth outcomes. For example, each faux-stained microscopy image sample may be a whole slide image (WSI) representing, e.g., a tumor biopsy or other sample. Each image sample may be associated with a ground truth outcome, which may correspond to a ground truth state of disease progression (e.g., metastasis occurred, metastasis did not occur, etc.) within a given time window (e.g., one year, five years, ten years, etc.). Ground truth outcomes may be obtained from manual annotations (e.g., by a physician), and/or obtained from a health records database.

At 1504, process 1500 can divide the set of faux-stained microscopy image samples into a training set and a validation set. Each of the training set and the validation set may include a mix of ground truth outcomes. For example, in an instance in which the ground truth outcomes include whether or not a tumor metastasized (e.g., Met+ and Met−), the training set may include a mix of Met+ and Met− samples, and similarly, the validation set may also include a mix of Met+ and Met− samples. Note that the number of each outcome may be the same for the training set and/or the validation set (e.g., 30 Met+ and 30 Met−, 50 Met+ and 50 Met−), or may be different (e.g., 30 Met+ and 60 Met−, 60 Met+ and 40 Met−), or the like. Note that samples included in the training set are not included in the validation set, and vice versa.

At 1506, process 1500 can perform initial training of the DNN by providing faux-stained microscopy image samples associated with the training set to the DNN and updating weights of the DNN based on a difference between a predicted outcome and the ground truth outcome. For example, in some embodiments, process 1500 can generate a set of sub-region images from a given faux-stained microscopy image sample by sampling the faux-stained microscopy image sample (e.g., ten samples, one hundred samples, one thousand samples, ten thousand samples, etc.). Continuing with this example, process 1500 can provide each sub-region image to the DNN to generate an outcome prediction. Process 1500 can then generate an aggregate outcome prediction by aggregating the outcome predictions associated with each sub-region (e.g., by determining a mean, a median, a weighted average, etc.). The aggregate outcome prediction, which may be a continuous value, may then be transformed to a binary value, e.g., by comparing the continuous value to a threshold. The weights may then be updated based on a comparison to the ground truth outcome. This process may be repeated for each faux-stained microscopy image in the training set. Note that weights of the DNN may be updated in batches, each batch comprising multiple training sample instances. Weights may be updated using any suitable techniques, such as backpropagation using gradient descent, etc.

At 1508, process 1500 can perform fine tuning of the DNN by providing faux-stained microscopy image samples associated with the validation set to the DNN. During the fine tuning stage, hyperparameters of the DNN (e.g., learning rate, batch size, weight decay, number of epochs, and/or learning scheduler) may be updated based on a difference between a predicted outcome associated with a validation set sample and the ground truth outcome. Note that, as used herein, a “learning scheduler” may be a process that allows control of how the learning rate is modified, e.g., according to learning schedule hyperparameter, or based on performance improvements (which may be specified as one or more hyperparameters). Similar to what is described above in connection with block 1506, during the fine tuning stage, process 1500 may sample a faux-stained microscopy image sample of the validation set to generate a set of sub-region images, each of which are provided to the DNN. An outcome prediction may be generated by the DNN for each sub-region image, which may then be aggregated to form an aggregate outcome prediction. The aggregate outcome prediction may be transformed to a binary outcome prediction, and the hyperparameters may be updated based on a comparison of the binary outcome prediction to the ground truth outcome prediction.

FIG. 13B is a schematic illustration of operations for training and validating a deep neural network 1340 for outcome predictions, according to embodiments. As illustrated, the set of faux stained images 1330 of unstained samples from a cohort of patients is divided into a training set 1332 and a validation set 1334. The DNN is trained using the training set 1332 and validation set 1334. Each faux-stained microscopy image may be annotated for regions of interest associated with a ground truth outcome. For example, the faux-stained microscopy images may correspond to tumor biopsy images, and the ground truth outcome may indicate a disease progression outcome, such as whether metastasis to a different body region occurred. For example, for a given faux-stained microscopy image, a corresponding label may be “High risk” or “Low Risk” of disease progression such as metastasis.

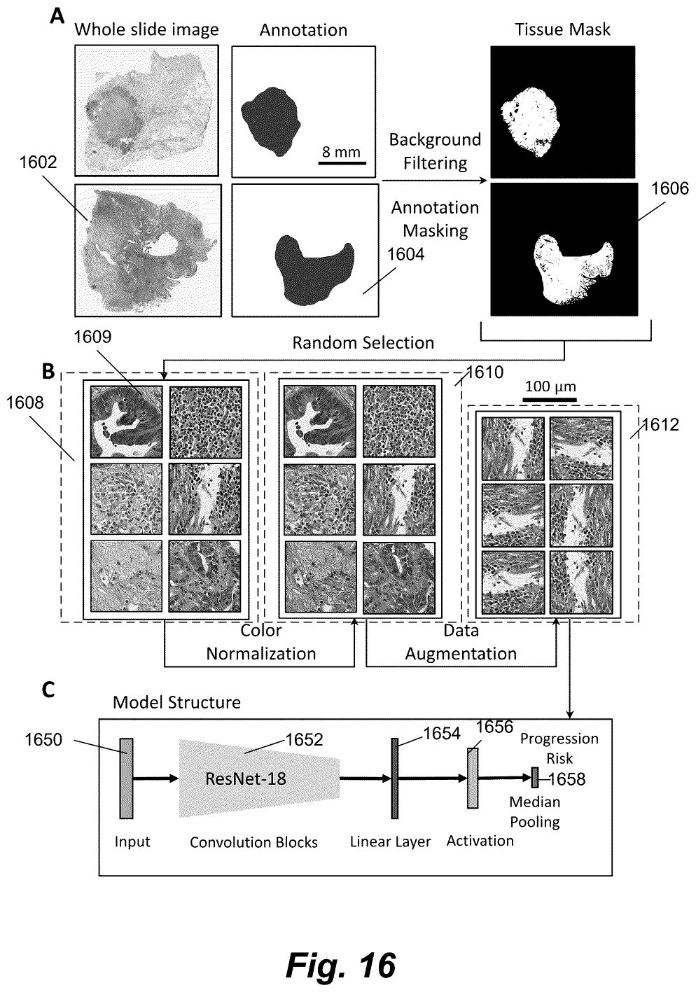

FIG. 16 illustrates example techniques for generating samples (e.g., training samples, validation samples, and/or test samples) provided as input to a DNN as well as an example DNN architecture that may be utilized.

As shown in panel A of FIG. 16, a whole slide image (such as whole slide image 1602) is obtained, which may depict a test sample. The test sample may include a tumor biopsy, a biopsy of other tissue, or any suitable type of test sample. The whole slide image may be a faux-stained microscopy image that is computationally generated by, for example, method 800 in FIG. 8. In some embodiments, the faux-stained microscopy image may be digitally focused by, for example, an APIC technique.

An annotation of a region of interest, such as annotation 1604, may be used to generate a mask, such as mask 1606. For example, annotation 1604 indicates a tumor region present in whole slide image 1602. Based on the annotation, background regions not part of the annotated region of interest may be filtered out to generate the mask. The annotation may be obtained from manual annotation (e.g., a pathologist may indicate regions of the whole slide image that indicate a region of interest). Additionally or alternatively, in some embodiments, the annotation may be generated using a trained machine learning model, such as a trained convolutional network, which may be trained to identify bounds of a region of interest. Such a trained machine learning model may be separate from a DNN configured to perform outcome prediction, and may itself be trained using manually annotated samples.

For each whole slide image, a set of sub-images from within the region of interest may be generated, where each sub-image is provided separately as input to the DNN. For example, set of sub-images 1608 include random samples from a region of interest identified in mask 1606. For example, sub-image 1609 is included in set of sub-images 1608. Each sub-image may be of any suitable size, such as 100 pixels by 100 pixels, 150 pixels by 150 pixels, 300 pixels by 300 pixels, 400 pixels by 400 pixels, etc. Note that each sub-image may be obtained by random sampling within the region of interest. Additionally, note that while the whole slide image may have a size in the range of megapixels or even gigapixels, each sub-image may be substantially smaller, e.g., on the order of thousands or tens of thousands of pixels. In one example, each sub-image may undergo pre-processing, such as color normalization.

Samples included in a training set may undergo a data augmentation procedure to expand the range of samples a DNN is trained on. For example, as shown in set of sub-images 1612, data augmentation may involve random cropping, flipping, rotating, etc. sub-images from set of sub-images 1608 and/or 1610.

Panel C of FIG. 16 depicts an example architecture of a DNN that may be used in accordance with some embodiments. As illustrated, at input 1650 is provided as an input to a set of convolutional blocks 1652. Input 1650 may be a vector representation of a sub-image. In an initial training phase, the sub-image may be from a training set (e.g., a sub-image sampled from a whole slide image assigned to a training set, or a sub-image obtained from data augmentation from a sub-image sampled from a training set whole slide image). In a fine tuning stage, the sub-image may be from a validation set (e.g., a sub-image sampled from a whole slide image assigned to a validation set, or a sub-image obtained from data augmentation from a sub-image sampled from a training set whole slide image). At an inference state, the sub-image may be from a test set (e.g., a sub-image sampled from a test whole slide image).

Convolution blocks 1652 may comprise one or more convolutional layers. Each convolutional layer may be configured to extract features of input 1650. Extracted features may be passed to a subsequent convolutional layer. In the example shown in FIG. 16, a ResNet-18 architecture with 18 convolutional layers is used, but this is merely an example, and any suitable number of convolutional blocks or layers may be used (e.g., five, ten, twenty, one hundred, etc.).

The output of convolutional blocks 1652 is provided to a linear layer 1654. A linear layer, sometimes referred to as a fully-connected layer, connects every input node to every output node. The output of linear layer 1654 is provided to an activation function 1656. In some embodiments, activation function 1656 may be a sigmoid function, or a softmax function. The output of activation function 1656 may be a continuous value (e.g., between −1 and 1, between 0 and 1, etc.) that indicates a likelihood of a given outcome (e.g., metastasis, transition of a cancer from early stage to invasive, etc.).

Note that, as described above in connection with FIGS. 14 and 15, multiple sub-images may be provided to a DNN, with output predictions generated for each sub-image. The output predictions for the set of sub-images may then be aggregated using median pooling layer 1658. For example, the output predictions from each sub-image may be aggregated and a median output prediction may be identified using median pooling layer 1658. The output of median pooling layer 1658 may correspond to the aggregate output prediction. As described above, aggregating output predictions by finding a median output prediction is merely one example, and, in some embodiments, output predictions may be aggregated using a mean (with or without outlier data discarded), a weighted average, or the like.

In some embodiments, a DNN may be pre-trained using an image database prior to an initial training phase that utilizes a training set of faux-stained microscopy images. The weights obtained using the pre-training phase may be used to initialize the DNN at the start of the initial training phase.

It should be noted that a DNN may have any suitable architecture and is not limited to the architecture shown in panel C of FIG. 16. For example, in some embodiments, a DNN may have one or more attention layers or other attention mechanisms, such as those implemented in a transformer network. As another example, in some embodiments, a DNN may use different activation functions, such as sigmoid, softmax, etc. As yet another example, in some embodiments, a DNN may execute different pooling functions, such as attention pooling, average pooling, etc. Such attention mechanisms may allow a DNN to select regions that should be attended to when determining predictions.

### IV. Additional Examples of Stain-Free All-in-Focus Imaging Systems

FIG. 17 is a block diagram of example components of a stain-free all-in-focus imaging system 1700, according to various embodiments. The stain-free all-in-focus imaging system 1700 includes a stain-free all-in-focus imaging device 1701 and a computing device 1780 in electronic communication. In certain implementations, stain-free all-in-focus imaging system 1700 can implement the method 800 in FIG. 8 to computationally generate one or more faux-stained all-in-focus images, implement the method 1500 in FIG. 15 to train a machine learning model, and/or implement the method 1400 in FIG. 14 to use a trained machine model to generate an outcome prediction.

The stain-free all-in-focus imaging device 1701 includes an illumination device 1710 with one or more first light sources for emitting light at a first wavelength or range of first wavelengths and one or more first light sources for emitting light at a second wavelength or range of second wavelengths. In certain instances, the light of the first wavelength(s) and/or light of the second wavelength(s) is emitted at a plurality of illumination angles over a sequence of exposure times. For example, the illumination device 1710 may include a plurality of light sources or include a light source that can be moved to different positions to provide illumination from different locations to provide illumination at different illumination angles to the specimen being imaged.

Stain-free all-in-focus imaging device 1701 also includes a first light detector 1742 configured to take one or more first measurements indicative of light of the first wavelength(s) transmitted through or reflected by the specimen. In addition, stain-free all-in-focus imaging device 1701 includes a second light detector 1744 configured to take one or more second measurements indicative of light of the second wavelength(s) transmitted through or reflected by the specimen.

In some cases, the illumination device 1710 and first light detector 1742 are configured in transmission mode such that measurements captured by the first light detector 1742 are indicative of light transmitted through a specimen being imaged in a specimen holder 1720 (e.g., slide or other receptacle). In some cases, the illumination device 1710 and second light detector 1744 are configured in transmission mode such that measurements captured by the second light detector 1744 are indicative of light transmitted through the specimen. In some cases, the illumination device 1710 and first light detector 1742 are configured in reflective mode such that measurements captured by the first light detector 1742 are indicative of light reflected by the specimen. In some cases, the illumination device 1710 and second light detector 1744 are configured in reflective mode such that measurements captured by the second light detector 1744 are indicative of light reflected by the specimen.

Stain-free all-in-focus imaging device 1701 also includes an optical system 1730 with collection optics such an objective for receiving illumination scattered by the specimen. The optical system may also include a beam splitter such as harmonic beam splitter that can separate light of the first wavelength(s) from light of the second wavelengths.

The computing device 1780 includes one or more processors 1782, a non-transitory computer readable medium (CRM) 1784, and an optional (denoted by dashed line) display 1786. Communication between one or more system components may be in wired and/or wireless form.

Various formats of illumination devices may be used by a stain-free all-in-focus imaging system, according to various embodiments. For example, in one embodiment, an illumination device may include a galvo motor configured to receive a laser beam and a plurality of mirrors configured to reflect the laser beam at different illumination angles. In another embodiment, an illumination device includes one or more rings of light sources mounted onto a supporting structure (e.g., a flat plate, a hemispherical plate, a semi-hemispherical plate, a partial conical plate, etc.). For example, an illumination device may have a first ring of light sources sized to emit light at illumination angles matching the acceptance angle of the collection optics and a second ring of light sources sized to emit light at illumination angles greater than the acceptance angle for darkfield imaging. In another embodiment, the illumination device may include a single light source that may be moved to different positions to emit light at different illumination angles. In another embodiment, the illumination device may include a rectangular array of light sources and/or a ring of light sources. Various types of light sources may be used such as LEDs, LCDs, and the like. The light sources of different embodiments may provide electromagnetic waves of various wavelength. In some cases, the light sources of the illumination device provide wavelength within the visible spectrum. In another case, the light sources provide electromagnetic waves in the ultraviolet spectrum such as in deep ultraviolet spectrum. In another case, the light sources provide electromagnetic waves in the infrared spectrum.

In some embodiments, a stain-free all-in-focus imaging system has one or more motorized translational stages upon which the illumination device is mounted to adjust the position (height and x-y translational position) of the illumination device. In some cases, the motorized transitional stage(s) is/are in communication with the computing device of the stain-free all-in-focus imaging system to control the movement. In one implementation, two motorized transitional stages are used.

In various embodiments, a stain-free all-in-focus imaging system includes one or more light detectors configured to receive light from the optical system and acquire one or more measurements. Each light detector generally includes a plurality of light detecting elements. Various arrangements of light detecting elements may be used such as, for example, charge coupled devices (CCDs), CMOS imaging sensors, an avalanche photo-diode (APD) array, a photo-diode (PD) array, or a photomultiplier tube (PMT) array.

A stain-free all-in-focus imaging system may include a computing device for performing one or more functions of the system. The computing device may include one or more processors and a non-transitory computer readable medium in electrical communication with the one or more processors. Optionally, the computing device may also have a display that is in electrical communication with the one or more processors. The computing device can be in various forms such as, for example, a smartphone, laptop, desktop, tablet, etc.

In some cases, the computing device may be, or include, a controller for controlling functionality of the stain-free all-in-focus imaging system. The controller may include one or more circuit boards such as printed circuit boards.

In various embodiments, a stain-free all-in-focus imaging system includes one or more processors (e.g., processor(s) 1882 in FIG. 18) and non-transitory computer readable medium (CRM) (e.g., memory) (e.g., computer readable medium 1884 in FIG. 18 and computer readable medium 2470 in FIG. 24) in communication with the processor(s). The processor(s) and can retrieve processor-executable code from the CRM or other memory to perform various functions or operations of a stain-free all-in-focus imaging method. The CRM or other memory can store raw and/or processed image data. In some implementations, the CRM or other memory can additionally or alternatively include a volatile memory array for temporarily storing code to be executed as well as image data to be processed, stored, or displayed.

In some embodiments, the illumination device includes a plurality of light sources that can provide light sequentially at a corresponding plurality illumination angles that correspond to an acceptance angle of the collection optics of the optical system 1830. For example, the light source may be arranged in a ring with a diameter that provides illumination angles that match the acceptance angle of an objective. In darkfield imaging embodiments, the illumination device may include one or more light sources that provide illumination outside the acceptance angle of the collection optics such that darkfield measurements are captured at the light detector. For example, the illumination device 1910A in FIG. 19A and the illumination device 1910B in FIG. 19B are examples of illumination devices that can be utilized for darkfield imaging.

FIG. 19A depicts a plan view of an example of an illumination device 1910A that can be used for intensity imaging and/or darkfield imaging, according to embodiments. Illumination device 1910A includes a ring of first light sources 1912A (first ring) and a ring of second light sources 1914A (second ring) mounted onto a surface of a flat plate 1911A. The first ring has a circumference (with a diameter, D₁) defined along the centers of the first light sources 1912A. The circumference of the first ring and the arrangement/positioning of the first ring with respect to the collection optics are designed such that light emitted from the first light sources 1912A is at different illumination angles (sometimes referred to as “NA matching illumination angles”) at or near the acceptance angle of the collection optics. The second ring has a circumference (with a diameter, D₂) defined along the centers of the second light sources 1914A. The size and positioning of the second ring with respect to the collection optics is configured such that the second light sources 1914A provide illumination outside the acceptance angle for darkfield illumination. Additional rings of light sources may be used in other implementations. Also, each ring may include fewer or more light sources according to other implementations.

FIG. 19B depicts a plan view of an example of an illumination device 1910B that can be used for intensity imaging and/or darkfield imaging, according to embodiments. Illumination device 1910B includes a ring of first light sources 1912B (first ring) and a ring of second light sources 1914A (second ring) mounted onto a surface of a flat plate 1911B. The first ring has a circumference defined along the centers of the first light sources 1912B. The circumference of the first ring and the arrangement/positioning of the first ring with respect to the collection optics are designed such that light emitted from the first light sources 1912B is at different illumination angles at or near the acceptance angle of the collection optics. The second ring has a circumference defined along the centers of the second light sources 1914B. The size and positioning of the second ring with respect to the collection optics is configured such that the second light sources 1914B provide illumination outside the acceptance angle for darkfield illumination. Additional rings of light sources may be used in other implementations. Also, each ring may include fewer or more light sources according to other implementations.

FIG. 20 is a side view of components of an example of a stain-free all-in-focus imaging system 2000, according to certain embodiments. As illustrated, stain-free all-in-focus imaging system 2000 includes an illumination device 2010 with a light source 2012 and an optical system 2030 with an aperture 2032 and an objective 2034 having an acceptance angle, θ. Stain-free all-in-focus imaging system 2000 also includes a light detector 2040. At the instant in time depicted in the illustrated example, a specimen 2020 being imaged is located on a receptacle 2022 (e.g., transparent slide). Stain-free all-in-focus imaging system 2000 also includes a mechanism (not shown) coupled to the light source 2012. The mechanism is configured to move (e.g., scan) the light source 2012 in a direction of an x-axis and/or in a direction of a y-axis (not shown) perpendicular to a plane of the x-axis and the z-axis.

In FIG. 20, the light source 2012 is depicted as moving (shown as dashed arrow) between three positions, 2011A, 2011B, and 2011C. At the first two positions 2011A, 2011B, the light source 2012 is providing illumination 2016 at an illumination angle, α, that is equal to the acceptance angle, θ, of the objective 2034. At a third position, 2011C, the light source 2012 is providing darkfield illumination 2017 at an illumination angle that is greater than the acceptance angle, θ. Although three positions are shown, it would be understood that the light source 2012 may be moved to additional positions according to other examples.

During operation, the light detector 2040 acquires a plurality of intensity measurements while illumination 2016 is provided at a plurality of illumination angles matching the acceptance angle of the objective 2034 (also sometimes referred to herein as NA-matching measurements). The light detector 2040 also acquires one or more darkfield measurements while darkfield illumination 2017 is provided at one or more darkfield illumination angles greater than acceptance angle of the objective 2034.

In an alternative embodiment, the stain-free all-in-focus imaging system 2000 may be configured to move the receptacle 2022 relative to the light source 2012 while keeping the light source 2012 stationary. In another alternative embodiment, the stain-free all-in-focus imaging system 2000 may be configured to move the optical system 2030 and light detector 2040 relative to the light source 2012 and receptacle 2022 while keeping to the light source 2012 and receptacle 2022 stationary.

FIG. 21 is a side view of components of an example of a stain-free all-in-focus imaging system 2100, according to an embodiment. Stain-free all-in-focus imaging system 2100 includes an illumination device 2110 with a single light source 2112 and an optical system 2130 with an aperture 2132 and an objective 2134 having a lens with an acceptance angle, θ. At the instant in time depicted in the illustrated example, a specimen 2120 being imaged is located on a transparent receptacle 2122 (e.g., transparent slide). Stain-free all-in-focus imaging system 2100 also includes a (first) ring of first light detectors 2140a and a (second) ring of second light detectors 2140b.

Stain-free all-in-focus imaging system 2100 also includes a (first) ring of first light detectors 2140a and a second ring of second light detectors 2140b configured to acquire a plurality of darkfield measurements. The first light detectors 2140a in the first ring are positioned such that their respective detection planes 2141a are perpendicularly facing the illumination angles matching the acceptance angle of the collection optical element 2134 to be able to capture a respective plurality of intensity measurements during operation. The light detectors in the second ring 2140b are positioned such that their respective detection planes 2141b are perpendicularly facing the illumination angles greater than the acceptance angle to be able to capture one or more darkfield intensity measurements during operation.

In the illustrated example, a single light source 2112 may be implemented and may remain stationary. During each image acquisition, an intensity image indicative of light at one illumination angle matching the acceptance angle of the objective 2134 may be captured by one of the light detectors of the first ring 2140 and simultaneously a darkfield image indicative of light at an illumination angle greater than the acceptance angle of the objective 2134 may be captured by one of the light detectors of the second ring 2140.

In certain embodiments, a stain-free all-in-focus imaging system includes an illumination device that directs a laser beam at one or more illumination angles matching the acceptance angle of the collection optics and one or more illumination angles greater than the acceptance angle. In one example, the illumination device may include a galvo motor (two-axis rotatable mirror system) and an array of mirrors (e.g., an arrangement of mirrors in concentric circles along a flat surface). The galvo motor may have mirrors that are rotatable to direct a laser beam to different mirrors in the array that then reflect the laser beam at the different illumination angles. The galvo motor is in communication with one or more laser sources (e.g., via optical fibers) to receive the laser beam.

FIG. 22 depicts an orthogonal view of a stain-free all-in-focus imaging system 2200 having an illumination device 2210 with a galvo motor 2211 and a circular mirror array 2215, according to an embodiment. Galvo motor 2211 includes first and second rotatable mirrors 2213 and 2214. Circular mirror array 2215 includes ninety five (95) mirrors 2216(1)-2216(95). Other numbers of mirrors can be used in other implementations. Each mirror 2216(i) of the circular mirror array 2215 is coupled at one end of a rectangular tower coupled to a plate. The rectangular towers may be 3D-printed structures. Each tower's top surface is sloped at a certain angle such that collimated laser beam 2204 may be reflected towards the sample plane at one of the illumination angles in the sequence of illumination angles. In one implementation, a neutral density filter may be placed on each of the mirrors 2216(1)-2216(95) in circular mirror array 2215. Use of such neutral density filters allows for increasing the input laser intensity to obtain higher SNR in dark field images while preventing the bright field images from over-exposure. While two rotatable mirrors 2213 and 2214 are depicted in FIG. 22, a single mirror rotatable about two different axes can be used in another implementation.

The stain-free all-in-focus imaging system 2200 also includes an optical system 2230 and a light detector 2240 for receiving laser light propagated by optical system 2230. Optical system 2230 includes a collection optical element 2234 (e.g., objective) having a focal length, f₁, and a focusing clement 2236 (e.g., lens) having a focal length, f₂. Collection optical element 2234 is located to receive light issuing from the specimen during operation. Focusing element 2236 is configured to focus light propagated from collection optical element 2234 to light detector 2240. Optical system 2230 may be in a 4f arrangement or a 6f arrangement in certain implementations. Stain-free all-in-focus imaging system 2200 also includes a specimen receptacle 2222 (e.g., slide) for receiving a specimen being imaged. specimen receptacle 2222 includes a first surface at a sample plane. The illustrated example is shown at an instant in time during an image acquisition process where a specimen 2220 is located in specimen receptacle 2222.

The first and second rotatable mirrors 2213 and 2214 may be controlled in a variety of manners. By way of example, a controller, may be coupled with the first and second rotatable mirrors 2213 and 2214 of FIG. 22. The controller may access instructions stored in a memory. The instructions may be executable by the controller to cause the first and second rotatable mirrors 2213 and 2214 of FIG. 22 to or rotate to any given position such that the specimen is illuminated at each of the illumination angles at each of the different sampling times, as described in the preceding paragraph. Alternatively, the first and second rotatable mirrors 2213 and 2214 may have an internal memory and processor and may be programed to cause each of the first and second rotatable mirrors 2213 and 2214 to follow a pre-determined rotation path.

### Computational Systems

The techniques described above may be implemented using one or more computing devices. For example, a machine learning model such as a DNN may be trained and/or utilized at inference time using a computational device such as a server device, a laptop computer, a desktop computer, or the like. FIGS. 23 and 24 illustrate examples of computing devices that may be used, e.g., to implement functions of stain-free all-in-focus imaging methods described herein.

In FIG. 23, the computing device(s) 2380 includes a bus 2301 coupled to an input/output (I/O) subsystem 2302, one or more processors 2382, one or more communication interfaces 2307, a main memory 2308, a secondary memory 2310, and a power supply 2340. One of more of these components may be in separate housing. According to certain implementations, the illustrated components may be examples of components that are part of computing device 280 in FIG. 2 or a part of computing device 1880 in FIG. 18. Computing device 2380 includes I/O subsystem 2302, which includes, or is in communication with, one or more components which may implement an interface for interacting with human users and/or other computer devices depending upon the application.

Certain embodiments disclosed herein may be implemented in program code on computing device 2380 with I/O subsystem 2302 used to receive input program statements and/or data from a human user (e.g., via a graphical user interface (GUI), a keyboard, touchpad, etc.) and to display them back to the user, for example, on a display. The I/O subsystem 2302 may include, e.g., a keyboard, mouse, graphical user interface, touchscreen, or other interfaces for input, and, e.g., an LED or other flat screen display, or other interfaces for output. Other elements of embodiments may be implemented with a computer system like that of computer system 2300 without I/O subsystem 2302. According to various embodiments, a processor may include a CPU, GPU or computer, analog and/or digital input/output connections, controller boards, etc.

Program code may be stored in non-transitory computer readable media such as secondary memory 2310 or main memory 2308 or both. One or more processors 2304 may read program code from one or more non-transitory media and execute the code to enable computing device 2380 to accomplish the methods performed by various embodiments described herein, such as APIC imaging methods. Those skilled in the art will understand that the one or more processors 2382 may accept source code and interpret or compile the source code into machine code that is understandable at the hardware gate level of the one or more processors 2382.

Communication interfaces 2307 may include any suitable components or circuitry used for communication using any suitable communication network (e.g., the Internet, an intranet, a wide-area network (WAN), a local-area network (LAN), a wireless network, a virtual private network (VPN), and/or any other suitable type of communication network). For example, communication interfaces 2307 can include network interface card circuitry, wireless communication circuitry, etc.

In certain embodiments, computing device 2380 may be part of or connected to a controller that is employed to control functions of various system components described herein. For example, computing device 2380 may control image acquisition by a light detector (e.g., UV light detector 270 in FIG. 2 and visible light detector 240 in FIG. 2) and/or illuminations by an illumination device (e.g., illumination device 210 in FIG. 2). The controller will typically include one or more memory devices and one or more processors. The processor may include a CPU or computer, analog and/or digital input/output connections, stepper motor controller boards, etc.

In FIG. 24, the computing device(s) 2450 includes one or more processors 2460 (e.g., microprocessors), a non-transitory computer readable medium (CRM) 2470 in communication with the processor(s) 2460, and one or more displays 2480 also in communication with processor(s) 2460. Processor(s) 2460 is in electronic communication with CRM 2470 (e.g., memory). Processor(s) 2460 is also in electronic communication with display(s) 2480, e.g., to display image data, text, etc. on display 2480. Processor(s) 2460 may retrieve and execute instructions stored on the CRM 2470 to perform one or more functions described above. For example, processor(s) 2460 may execute instructions to perform one or more operations to generate an outcome prediction, train a DNN to generate outcome predictions, etc. The CRM (e.g., memory) 2470 can store instructions for performing one or more functions of the described above. These instructions may be executable by processor(s) 2470. CRM 2470 can also store raw images, e.g., microscopy images, sub-images sampled from an image, or the like.

Many types of computing devices having any of various computer architectures may be employed as the disclosed systems for implementing algorithms. For example, the computing devices may include software components executing on one or more general purpose processors or specially designed processors such as Application Specific Integrated Circuits (ASICs) or programmable logic devices (e.g., Field Programmable Gate Arrays (FPGAs)). Further, the systems may be implemented on a single device or distributed across multiple devices. The functions of the computational elements may be merged into one another or further split into multiple sub-modules.

At one level a software element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The algorithms used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines.

In addition, certain embodiments relate to tangible and/or non-transitory computer readable media or computer program products that include program instructions and/or data (including data structures) for performing various computer-implemented operations. Examples of computer-readable media include, but are not limited to, memory devices, phase-change devices, magnetic media such as disk drives, magnetic tape, optical media such as CDs, magneto-optical media, and hardware devices that are specially configured to store and perform program instructions, such as read-only memory devices (ROM) and random access memory (RAM). The computer readable media may be directly controlled by an end user or the media may be indirectly controlled by the end user. Examples of directly controlled media include the media located at a user facility and/or media that are not shared with other entities. Examples of indirectly controlled media include media that is indirectly accessible to the user via an external network and/or via a service providing shared resources such as the “cloud.” Examples of program instructions include both machine code, such as produced by a compiler, and files containing higher level code that may be executed by the computer using an interpreter.

In some embodiments, code executed during generation or execution of various models on an appropriately programmed system can be embodied in the form of software elements which can be stored in a nonvolatile storage medium (such as optical disk, flash storage device, mobile hard disk, etc.), including a number of instructions for making a computing device (such as personal computers, servers, network equipment, etc.).In various embodiments, the data or information employed in the disclosed methods and apparatus is provided in an electronic format. Such data or information may include design layouts, fixed parameter values, floated parameter values, feature profiles, metrology results, and the like. As used herein, data or other information provided in electronic format is available for storage on a machine and transmission between machines. Conventionally, data in electronic format is provided digitally and may be stored as bits and/or bytes in various data structures, lists, databases, etc. The data may be embodied electronically, optically, etc.

### Example Embodiments

Embodiment 1: A system comprising: an illumination device; a first light detector; a second light detector; and one or more processors. The one or more processors configured to: cause the illumination device to emit light in a first wavelength range and a second wavelength range; obtain, using the first light detector, information indicative of light of the first wavelength range reflected by, or transmitted through, an unstained specimen; obtain, using the second light detector, information indicative of light of the second wavelength range reflected by, or transmitted through, the unstained specimen; and based on the information obtained from the first and second light detectors, computationally generate a faux-stain image of the unstained specimen.

Embodiment 2: The system of embodiment 1, wherein the first wavelength range is a visible light wavelength range and the second wavelength range is an ultraviolet light wavelength range.

Embodiment 3: The method of embodiment 1, wherein the one or more processors are further configured to: provide the faux-stain image as input to a trained deep neural network; and determine an outcome prediction based on output of the trained deep neural network.

Embodiment 4: The method of embodiment 3, wherein the outcome prediction is a likelihood of metastasis of a tumor to a body region different from a body region associated with the unstained specimen.

Embodiment 5: A method comprising: causing, using one or more first light sources, light in a first wavelength range to be emitted at a plurality of illumination angles sequentially; obtaining, using a first light detector, a plurality of first intensity measurements indicative of light transmitted through, or reflected by an unstained specimen, the plurality of first intensity measurements corresponding to respective plurality of illumination angles; generating a first image from the plurality of first intensity measurements; causing, using one or more second light sources, light in a second wavelength range to be emitted; and obtaining, using a second light detector, a second image indicative of light in the second wavelength range absorbed by the unstained specimen; and combining the first image and the second image to produce a faux-stained image.

Embodiment 6: The method of embodiment 5, wherein the first image is a phase image.

Embodiment 7: The method of embodiment 6, further comprising reconstructing the phase image from the plurality of first intensity measurements using an angular ptychographic imaging with closed form procedure.

Embodiment 8: The method of embodiment 7, wherein reconstructing the first image from the plurality of first intensity measurements includes computationally focusing the first image.

Embodiment 9: The method of embodiment 5, further comprising digitally focusing the first image and/or the second image.

Embodiment 10: The method of embodiment 5, wherein the illumination angles are oblique angles with respect to a surface of a receptacle holding the unstained specimen.

Embodiment 11: The method of embodiment 5, wherein the illumination angles are equal to, or nearly equal to, an acceptance angle of collection optics configured to collect the light reflected by, or transmitted through, the unstained specimen.

Embodiment 12: The method of embodiment 5, further comprising: providing the faux-stain image as input to a trained deep neural network; and determining an outcome prediction based on output of the trained deep neural network.

Embodiment 13: A method, comprising: (a) computationally generating a faux-stain image of an unstained specimen using a plurality of first intensity measurements of light in a first wavelength range and at least one second intensity measurement of light in a second wavelength range; (b) providing the faux-stain image as input to a trained deep neural network; and (c) determining an outcome prediction based on output of the trained deep neural network.

Embodiment 14: The method of embodiment 13, wherein the outcome prediction is a likelihood of metastasis of a tumor to a body region different from a body region associated with the unstained specimen.

Embodiment 15: The method of embodiment 13, further comprising: causing, using one or more first light sources, light in the first wavelength range to be emitted at a plurality of illumination angles sequentially; obtaining, using a first light detector, the plurality of first intensity measurements indicative of light transmitted through, or reflected by the unstained specimen, each of the first intensity measurements corresponding to a respective one illumination angle of the plurality of illumination angles; causing, using one or more second light sources, light in a second wavelength range to be emitted; and obtaining, using a second light detector, the at least one second intensity measurement indicative of light in the second wavelength range absorbed by the unstained specimen.

Embodiment 16: The method of embodiment 13, further comprising: reconstructing a phase image from the plurality of first intensity measurements; and combining the phase image with the at least one second intensity measurement to produce the faux-stained image.

Embodiment 17: The method of embodiment 16, wherein the phase image is reconstructed using an angular ptychographic imaging with closed form procedure.

Embodiment 18: The method of embodiment 13, further comprising: generating a first image from the plurality of first intensity measurements; generating a second image from the at least one second intensity measurement; and combining the first image and the second image to produce the faux-stain image.

Embodiment 19: The method of embodiment 18, further comprising digitally focusing the first image and/or the second image.

Embodiment 20: The method of embodiment 18, wherein the first image and/or the second image is a darkfield image, a phase image, an autofluorescence image, a fluorescence lifetime image, or a polarization image.

Embodiment 21: The method of embodiment 18, wherein the second image is an ultraviolet absorption image.

Embodiment 22: The method of embodiment 13, wherein the second wavelength range is an ultraviolet light wavelength range and the first wavelength range is a visible light wavelength range.

Embodiment 23: The method of embodiment 22, wherein the ultraviolet light wavelength range is between 250 nm and 280 nm.

Embodiment 24: The method of embodiment 13, further comprising digitally focusing the faux-stain image.

Embodiment 25: The method of embodiment 13, wherein (c) comprises: identifying a region of interest of the faux-stain image for analysis; randomly selecting a set of sub-images from within the region of interest; generating a set of outcome predictions, each outcome prediction associated with a corresponding sub-image of the set of sub-images by providing the sub-image to the trained deep neural network; and aggregating the outcome predictions of the set of outcome predictions to generate an outcome prediction.

Embodiment 26: The method of embodiment 25 wherein the outcome prediction is a median outcome prediction of the set of outcome predictions.

Embodiment 27: The method of embodiment 13, wherein the outcome prediction corresponds to a prediction of disease progression within a future time period.

Embodiment 28: A method, comprising: computationally generating a set of faux stain images of unstained specimens from a cohort of patients and corresponding ground truth predictions, wherein each ground truth prediction is indicative of an outcome for a patient within the cohort associated with one of the faux stain images; dividing the set of faux stain images and corresponding ground truth predictions into a training set and a validation set and performing an initial training of a deep neural network by: providing sub-images from a region of interest of a given faux stain image from the training set to the deep neural network; generating an aggregate outcome prediction for the given faux stain image based on outcome predictions associated with each sub-image of the given faux stain image; and updating weights of the deep neural network based on a difference between the aggregate outcome prediction and the ground truth prediction for the given faux stain image. The method further comprising performing fine-tuning of the deep neural network using the validation set, wherein the fine-tuning comprises updating at least one hyperparameter.

Embodiment 29: The method of embodiment 28, wherein the at least one hyperparameter comprises a learning rate, a batch size, a weight decay, a learning scheduler, or any combination thereof.

Embodiment 30: The method of embodiment 28, wherein the fine-tuning of the deep neural network comprises providing sub-images from the set of faux-stain images included in the validation set to the deep neural network.

Modifications, additions, or omissions may be made to any of the above-described embodiments without departing from the scope of the disclosure. Any of the embodiments described above may include more, fewer, or other features without departing from the scope of the disclosure. Additionally, the steps of described features may be performed in any suitable order without departing from the scope of the disclosure. Also, one or more features from any embodiment may be combined with one or more features of any other embodiment without departing from the scope of the disclosure. The components of any embodiment may be integrated or separated according to particular needs without departing from the scope of the disclosure.

It should be understood that certain aspects described above can be implemented in the form of logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code using any suitable computer language and/or computational software such as, for example, Java, C, C#, C++ or Python, LabVIEW, Mathematica, or other suitable language/computational software, including low level code, including code written for field programmable gate arrays, for example in VHDL. The code may include software libraries for functions like data acquisition and control, motion control, image acquisition and display, etc. Some or all of the code may also run on a personal computer, single board computer, embedded controller, microcontroller, digital signal processor, field programmable gate array and/or any combination thereof or any similar computation device and/or logic device(s). The software code may be stored as a series of instructions, or commands on a CRM such as a random access memory (RAM), a read only memory (ROM), a magnetic media such as a hard-drive or a floppy disk, or an optical media such as a CD-ROM, or solid stage storage such as a solid state hard drive or removable flash memory device or any suitable storage device. Any such CRM may reside on or within a single computational apparatus, and may be present on or within different computational apparatuses within a system or network. Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

1. A system comprising:
an illumination device;
a first light detector;
a second light detector; and
one or more processors configured to:
cause the illumination device to emit light in a first wavelength range and a second wavelength range;
obtain, using the first light detector, information indicative of light of the first wavelength range reflected by, or transmitted through, an unstained specimen;
obtain, using the second light detector, information indicative of light of the second wavelength range reflected by, or transmitted through, the unstained specimen; and
based on the information obtained from the first and second light detectors, computationally generate a faux-stain image of the unstained specimen.

2. The system of claim 1, wherein the first wavelength range is a visible light wavelength range and the second wavelength range is an ultraviolet light wavelength range.

3. The system of claim 1, wherein the one or more processors are further configured to:
provide the faux-stain image as input to a trained deep neural network; and
determine an outcome prediction based on output of the trained deep neural network.

4. The system of claim 3, wherein the outcome prediction is a likelihood of metastasis of a tumor to a body region different from a body region associated with the unstained specimen.

5. A method, comprising:
causing, using one or more first light sources, light in a first wavelength range to be emitted at a plurality of illumination angles sequentially;
obtaining, using a first light detector, a plurality of first intensity measurements indicative of light transmitted through, or reflected by an unstained specimen, the plurality of first intensity measurements corresponding to respective plurality of illumination angles;
generating a first image from the plurality of first intensity measurements;
causing, using one or more second light sources, light in a second wavelength range to be emitted;
obtaining, using a second light detector, a second image indicative of light in the second wavelength range absorbed by the unstained specimen; and
combining the first image and the second image to produce a faux-stained image.

6. The method of claim 5, wherein the first image is a phase image.

7. The method of claim 6, further comprising reconstructing the phase image from the plurality of first intensity measurements using an angular ptychographic imaging with closed form procedure.

8. The method of claim 7, wherein reconstructing the first image from the plurality of first intensity measurements includes computationally focusing the first image.

9. The method of claim 5, further comprising digitally focusing the first image and/or the second image.

10. (canceled)

11. The method of claim 5, wherein the illumination angles are equal to, or nearly equal to, an acceptance angle of collection optics configured to collect the light reflected by, or transmitted through, the unstained specimen.

12. (canceled)

13. A method, comprising:
(a) computationally generating a faux-stain image of an unstained specimen using a plurality of first intensity measurements of light in a first wavelength range and at least one second intensity measurement of light in a second wavelength range;
(b) providing the faux-stain image as input to a trained deep neural network; and
(c) determining an outcome prediction based on output of the trained deep neural network.

14. The method of claim 13, wherein the outcome prediction is a likelihood of metastasis of a tumor to a body region different from a body region associated with the unstained specimen.

15. The method of claim 13, further comprising:
causing, using one or more first light sources, light in the first wavelength range to be emitted at a plurality of illumination angles sequentially;
obtaining, using a first light detector, the plurality of first intensity measurements indicative of light transmitted through, or reflected by the unstained specimen, each of the first intensity measurements corresponding to a respective one illumination angle of the plurality of illumination angles;
causing, using one or more second light sources, light in a second wavelength range to be emitted; and
obtaining, using a second light detector, the at least one second intensity measurement indicative of light in the second wavelength range absorbed by the unstained specimen.

16. The method of claim 13, further comprising:
reconstructing a phase image from the plurality of first intensity measurements; and
combining the phase image with the at least one second intensity measurement to produce the faux-stain image.

17. (canceled)

18. The method of claim 13, further comprising:
generating a first image from the plurality of first intensity measurements;
generating a second image from the at least one second intensity measurement; and
combining the first image and the second image to produce the faux-stain image.

19. The method of claim 18, further comprising digitally focusing the first image and/or the second image.

20-24. (canceled)

25. The method of claim 13, wherein (c) comprises:
identifying a region of interest of the faux-stain image for analysis;
randomly selecting a set of sub-images from within the region of interest;
generating a set of outcome predictions, each outcome prediction associated with a corresponding sub-image of the set of sub-images by providing the sub-image to the trained deep neural network; and
aggregating the outcome predictions of the set of outcome predictions to generate an outcome prediction.

26. (canceled)

27. The method of claim 13, wherein the outcome prediction corresponds to a prediction of disease progression within a future time period.

28. A method comprising:
computationally generating a set of faux-stain images of unstained specimens from a cohort of patients and corresponding ground truth predictions, wherein each ground truth prediction is indicative of an outcome for a patient within the cohort associated with one of the faux-stain images;
dividing the set of faux-stain images and corresponding ground truth predictions into a training set and a validation set;
performing an initial training of a deep neural network by:
providing sub-images from a region of interest of a given faux-stain image from the training set to the deep neural network;
generating an aggregate outcome prediction for the given faux-stain image based on outcome predictions associated with each sub-image of the given faux-stain image;
updating weights of the deep neural network based on a difference between the aggregate outcome prediction and the ground truth prediction for the given faux-stain image; and
performing fine-tuning of the deep neural network using the validation set, wherein the fine-tuning comprises updating at least one hyperparameter.

29. (canceled)

30. The method of claim 28, wherein the fine-tuning of the deep neural network comprises providing sub-images from the set of faux-stain images included in the validation set to the deep neural network.
